(19) United States
(12) Patent Application Publication
(10) Pub. No.: US 2007/0178813 A1
(43) Pub. Date: Aug. 2, 2007

(54) Ophthalmic roughing wheel

(75) Inventor: Dennis R. Raffaelli, Oxford, MI (US)

Correspondence Address: WARN, HOFFMANN, MILLER & LALONE, .P.C, PO BOX 70098, ROCHESTER HILLS, MI, 48307, US

(73) Assignee: Inland Diamond Products Company, Madison Heights, MI (US)

(21) Appl. No.: 11/731,667

(22) Filed: Mar. 30, 2007

Related U.S. Application Data
(63) Continuation of application No. 10/829,630, filed on Apr. 22, 2004.
(60) Provisional application No. 60/505,564, filed on Sep. 24, 2003.

(51) Int. Cl. B24B 1/00; B23F 21/03

(52) U.S. Cl. 451/42; 451/541

(57) ABSTRACT

Ophthalmic rough-cut and polishing wheels having a plurality of swarf clearance grooves formed across the shaping face are described. The grooves are spaced around the shaping face of the wheels, wherein the slots are configured so as to be substantially angled either towards or away from one another.

### CROSS-REFERENCE TO RELATED APPLICATIONS

This application claims the benefit of U.S. Provisional Application No. 60/505,564, filed Sep. 24, 2003.

### FIELD OF THE INVENTION

The present invention relates generally to rough-cut and polishing wheels of the type used for edging of an optical edge. More specifically, the present invention relates to rough-cut and polishing wheels that reduce the necessary manual removal of swarf from the lens after rough cutting, fine grinding, finishing, polishing, and/or beveling of an optical lens, so as to improve lens edge quality and/or geometry.

### BACKGROUND OF THE INVENTION

Optical lenses are typically made of various materials, such as polycarbonates and high index plastics, as well as those materials currently marketed under the trade names CR39® and TRIVEX™ (both readily commercially available from PPG Industries, Pittsburgh, Pa.).

In order to finish and make these lenses ready for fitting into a lens frame, it is necessary to edge the outer periphery of the lens, to give it the proper cross-section to fit in an eyeglass lens frame. Typically, this is done by an edging machine, which includes a rough-cut wheel for cutting out the shape, fine grinding and finishing wheels for further shaping of the lens, and polishing and beveling wheels for providing the final contour.

Depending on the lens material, the grinding operation creates abrasive swarf material that requires removal in order for proper use of any type of abrasive device. Typically, the wheels have buildup of swarf during the operation, which imparts itself onto the lens or, alternatively, the grinding process does not remove the excess material. This creates the need to manually remove the swarf from the lens. Any swarf that is not readily removed during the grinding of the edging operation, interferes with the operation and, at the very least, slows it down and may add to several hand finishing steps necessary at the end, or an improper lens configuration.

TRIVEX™ has been a particularly troublesome material to shape and finish. However, TRIVEX™ does appear to be a new and preferred lens making material. Unfortunately, conventional forming wheels have resulted in much scrap and have otherwise been proved to be unsuitable for use with TRIVEX™ materials for lenses. Therefore, it has become a goal to provide an abrasive wheel capable of processing TRIVEX™ lenses that can also be used for all other type of lens materials.

In the optical industry today, the “one-hour” optical labs and the like have made it necessary for increased efficiencies in the processing of optical lens production. Therefore, it is desired to eliminate swarf removal on the optical lens by hand, regardless of the material used, which is labor intensive and time consuming.

Therefore, it is a goal in the art to provide rough-cut, fine grinding, finishing, polishing and/or beveling wheels, and methods for using the same, that eliminate the need for manual swarf removal.

### SUMMARY OF THE INVENTION

In accordance with one embodiment of the present invention, there is provided a rough-cutting wheel for rough cutting of an optical lens blank. The wheel comprises a hub portion that is adapted for attachment to a rotary power source. The wheel includes an outer circumferential cutting surface having a width. The outer circumferential cutting surface includes sufficient abrasive grit attached thereto to accomplish rough cutting of any conventional optical lens blank. The wheel includes a radially extending planar side portion, and in a preferred embodiment, has at least one swarf clearing groove extending at an angle to said side portion across the circumferential groove and opening into the planar side portion, which allows removal of swarf out through the planar side portion. In another preferred embodiment, each groove is preferably configured so as to be angled with respect to any adjacent groove, e.g., either angled towards or away from any adjacent groove. In a further preferred embodiment, the grooves may be present in multiple configurations, such as pairs and the like.

In accordance with another embodiment of the present invention, there is provided a polishing wheel for edge finishing of an optical lens blank. The wheel comprises a hub portion that is adapted for attachment to a rotary power source. The wheel includes an outer circumferential cutting surface having a width. The outer circumferential cutting surface includes sufficient abrasive grit attached thereto for polishing of an optical lens blank. The wheel includes a radially extending planar side portion, and in a preferred embodiment, has at least one swarf clearing groove extending at an angle to said side portion across the circumferential groove and opening into the planar side portion, which allows removal of swarf out through the planar side portion. In another preferred embodiment, each groove is preferably configured so as to be angled with respect to any adjacent groove, e.g., either angled towards or away from any adjacent groove. In a further preferred embodiment, the grooves may be present in multiple configurations, such as pairs and the like.

In accordance with a first alternative embodiment of the present invention, a rotary edging wheel for rough cutting of an optical lens is provided, comprising: (1) a hub portion operable for attachment to a rotary power source; (2) an outer circumferential rough cutting surface having a width, said surface including an abrasive grit attached thereto, wherein said abrasive grit is operable for rough cutting of the optical lens; and (3) at least one pair of substantially adjacent swarf clearing grooves formed in said surface, comprising: (a) a first swarf clearing groove extending at an angle across said surface; and (b) a second swarf clearing groove extending at an angle across said surface; wherein said first and second swarf clearing grooves are angled either towards each other or away from each other and extend continuously across said surface.

In accordance with a second alternative embodiment of the present invention, a rotary edging wheel for rough cutting of an optical lens is provided, comprising: (1) a hub portion operable for attachment to a rotary power source; (2) an outer circumferential rough cutting surface having a width, said surface including an abrasive grit attached thereto, wherein said abrasive grit is operable for rough cutting of the optical lens; (3) a first pair of substantially adjacent swarf clearing grooves formed in said surface, comprising first and second substantially parallel swarf clearing grooves extending at an angle across said surface; and (4) a second pair of substantially adjacent swarf clearing grooves formed in said surface, comprising third and fourth substantially parallel second swarf clearing grooves extending at an angle across said surface; wherein said first and second pairs of swarf clearing grooves are angled either towards each other or away from each other and extend continuously across said surface.

In accordance with a third alternative embodiment of the present invention, a rotary edging wheel for polishing of an optical lens is provided, comprising: (1) a hub portion operable for attachment to a rotary power source; (2) an outer circumferential cutting surface having a width, said surface including an abrasive grit attached thereto, wherein said abrasive grit is operable for polishing of the optical lens; and (3) at least one pair of substantially adjacent swarf clearing grooves formed in said surface, comprising: (a) a first swarf clearing groove extending at an angle across said surface; and (b) a second swarf clearing groove extending at an angle across said surface; wherein said first and second swarf clearing grooves are angled either towards each other or away from each other and extend continuously across said surface.

In accordance with a fourth alternative embodiment of the present invention, a rotary edging wheel for polishing of an optical lens is provided, comprising: (1) a hub portion operable for attachment to a rotary power source; (2) an outer circumferential cutting surface having a width, said surface including an abrasive grit attached thereto, wherein said abrasive grit is operable for polishing of the optical lens; (3) a first pair of substantially adjacent swarf clearing grooves formed in said surface, comprising first and second substantially parallel swarf clearing grooves extending at an angle across said surface; and (4) a second pair of substantially adjacent swarf clearing grooves formed in said surface, comprising third and fourth substantially parallel second swarf clearing grooves extending at an angle across said surface; wherein said first and second pairs of swarf clearing grooves are angled either towards each other or away from each other and extend continuously across said surface.

In accordance with a fifth alternative embodiment of the present invention, a method for rough cutting of an optical lens is provided, comprising: (1) providing an edging wheel, comprising: (a) a hub portion operable for attachment to a rotary power source; (b) an outer circumferential rough cutting surface having a width, said surface including an abrasive grit attached thereto, wherein said abrasive grit is operable for rough cutting of the optical lens; and (c) at least one pair of substantially adjacent swarf clearing grooves formed in said surface, comprising: (i) a first swarf clearing groove extending at an angle across said surface; and (ii) a second swarf clearing groove extending at an angle across said surface; wherein said first and second swarf clearing grooves are angled either towards each other or away from each other and extend continuously across said surface; (2) selectively rotating said edging wheel; and (3) bringing the optical lens into selective contact with said rotating edging wheel.

In accordance with a sixth alternative embodiment of the present invention, a method for rough cutting of an optical lens is provided, comprising: (1) providing a rotary edging wheel, comprising: (a) a hub portion operable for attachment to a rotary power source; (b) an outer circumferential rough cutting surface having a width, said surface including an abrasive grit attached thereto, wherein said abrasive grit is operable for rough cutting of the optical lens; (c) a first pair of substantially adjacent swarf clearing grooves formed in said surface, comprising first and second substantially parallel swarf clearing grooves extending at an angle across said surface; and (d) a second pair of substantially adjacent swarf clearing grooves formed in said surface, comprising third and fourth substantially parallel second swarf clearing grooves extending at an angle across said surface; wherein said first and second pairs of swarf clearing grooves are angled either towards each other or away from each other and extend continuously across said surface; (2) selectively rotating said edging wheel; and (3) bringing the optical lens into selective contact with said rotating edging wheel.

In accordance with a seventh alternative embodiment of the present invention, a method for polishing of an optical lens is provided, comprising: (1) providing a rotary edging wheel, comprising: (a) a hub portion operable for attachment to a rotary power source; (b) an outer circumferential cutting surface having a width, said surface including an abrasive grit attached thereto, wherein said abrasive grit is operable for polishing of the optical lens; and (c) at least one pair of substantially adjacent swarf clearing grooves formed in said surface, comprising: (i) a first swarf clearing groove extending at an angle across said surface; and (ii) a second swarf clearing groove extending at an angle across said surface; wherein said first and second swarf clearing grooves are angled either towards each other or away from each other and extend continuously across said surface; (2) selectively rotating said edging wheel; and (3) bringing the optical lens into selective contact with said rotating edging wheel.

In accordance with an eighth alternative embodiment of the present invention, a method for polishing an optical lens is provided, comprising: (1) providing a rotary edging wheel, comprising: (a) a hub portion operable for attachment to a rotary power source; (b) an outer circumferential cutting surface having a width, said surface including an abrasive grit attached thereto, wherein said abrasive grit is operable for polishing of the optical lens; (c) a radially extending planar side portion; (d) a first pair of substantially adjacent swarf clearing grooves formed in said surface, comprising first and second substantially parallel swarf clearing grooves extending at an angle across said surface; and (e) a second pair of substantially adjacent swarf clearing grooves formed in said surface, comprising third and fourth substantially parallel second swarf clearing grooves extending at an angle across said surface; wherein said first and second pairs of swarf clearing grooves are angled either towards each other or away from each other and extend continuously across said surface; (2) selectively rotating said edging wheel; and (3) bringing the optical lens into selective contact with said rotating edging wheel.

A further understanding of the present invention will be had in view of the description of the drawings and detailed description of the invention, when viewed in conjunction with the subjoined claims.

### BRIEF DESCRIPTION OF THE DRAWINGS

FIG. 1 is a perspective view of a roughing wheel, in accordance with a first embodiment of the present invention;

FIG. 2 is an elevational view of the roughing wheel depicted in FIG. 1, in accordance with the first embodiment of the present invention;

FIG. 3 is a top view of the roughing wheel depicted in FIGS. 1 and 2, in accordance with the first embodiment of the present invention;

FIG. 4 is a sectional plan view taken along line 4-4 of FIG. 2 of the roughing wheel depicted in FIGS. 1-3, in accordance with the first embodiment of the present invention;

FIG. 5 is a detailed side view illustrating the swarf-clearing groove of the roughing wheel depicted in FIGS. 1-4, in accordance with the first embodiment of the present invention;

FIG. 6 is a perspective view of a polishing wheel, in accordance with a second embodiment of the present invention;

FIG. 7 is an elevational view of the polishing wheel depicted in FIG. 6, in accordance with the second embodiment of the present invention;

FIG. 8 is a top view of the polishing wheel depicted in FIGS. 6 and 7, in accordance with the second embodiment of the present invention;

FIG. 9 is a sectional plan view taken along line 9-9 of FIG. 7 of the polishing wheel depicted in FIGS. 6-8, in accordance with the second embodiment of the present invention;

FIG. 10 is a detailed side view illustrating the swarf-clearing groove of the polishing roughing wheel depicted in FIGS. 6-9, in accordance with the second embodiment of the present invention;

FIG. 11 is a perspective view of a first alternative roughing wheel, in accordance with a third embodiment of the present invention;

FIG. 12 is an elevational view of the first alternative roughing wheel depicted in FIG. 11, in accordance with the third embodiment of the present invention;

FIG. 13 is a top view of the first alternative roughing wheel depicted in FIGS. 11 and 12, in accordance with the third embodiment of the present invention;

FIG. 14 is a sectional plan view taken along line 14-14 of FIG. 12 of the first alternative roughing wheel depicted in FIGS. 11-13, in accordance with the third embodiment of the present invention;

FIG. 15 is a detailed side view illustrating the swarf-clearing groove of the first alternative roughing wheel depicted in FIGS. 11-14, in accordance with the third embodiment of the present invention;

FIG. 16 is a perspective view of a first alternative polishing wheel, in accordance with a fourth embodiment of the present invention;

FIG. 17 is an elevational view of the first alternative polishing wheel depicted in FIG. 16, in accordance with the fourth embodiment of the present invention;

FIG. 18 is a top view of the first alternative polishing wheel depicted in FIGS. 16 and 17, in accordance with the fourth embodiment of the present invention;

FIG. 19 is a sectional plan view taken along line 19-19 of FIG. 17 of the first alternative polishing wheel depicted in FIGS. 16-18, in accordance with the fourth embodiment of the present invention;

FIG. 20 is a detailed side view illustrating the swarf-clearing groove of the first alternative polishing wheel depicted in FIGS. 16-19, in accordance with the fourth embodiment of the present invention;

FIG. 21 is a perspective view of a second alternative roughing wheel, in accordance with a fifth embodiment of the present invention;

FIG. 22 is an elevational view of the second alternative roughing wheel depicted in FIG. 21, in accordance with the fifth embodiment of the present invention;

FIG. 23 is a top view of the second alternative roughing wheel depicted in FIGS. 21 and 22, in accordance with the fifth embodiment of the present invention;

FIG. 24 is a sectional plan view taken along line 24-24 of FIG. 22 of the second alternative roughing wheel depicted in FIGS. 21-23, in accordance with the fifth embodiment of the present invention;

FIG. 25 is a detailed side view illustrating the swarf-clearing groove of the second alternative roughing wheel depicted in FIGS. 21-24, in accordance with the fifth embodiment of the present invention;

FIG. 26 is a perspective view of a second alternative polishing wheel, in accordance with a sixth embodiment of the present invention;

FIG. 27 is an elevational view of the second alternative polishing wheel depicted in FIG. 26, in accordance with the sixth embodiment of the present invention;

FIG. 28 is a top view of the second alternative polishing wheel depicted in FIGS. 26 and 27, in accordance with the sixth embodiment of the present invention;

FIG. 29 is a sectional plan view taken along line 29-29 of FIG. 27 of the second alternative polishing wheel depicted in FIGS. 26-28, in accordance with the sixth embodiment of the present invention;

FIG. 30 is a detailed side view illustrating the swarf-clearing groove of the second alternative polishing wheel depicted in FIGS. 26-29, in accordance with the sixth embodiment of the present invention;

FIG. 31 is a perspective view of a third alternative roughing wheel, in accordance with a seventh embodiment of the present invention;

FIG. 32 is an elevational view of the third alternative roughing wheel depicted in FIG. 31, in accordance with the seventh embodiment of the present invention;

FIG. 33 is a top view of the third alternative roughing wheel depicted in FIGS. 31 and 32, in accordance with the seventh embodiment of the present invention;

FIG. 34 is a sectional plan view taken along line 34-34 of FIG. 32 of the third alternative roughing wheel depicted in FIGS. 31-33, in accordance with the seventh embodiment of the present invention;

FIG. 35 is a detailed side view illustrating the swarf-clearing groove of the third alternative roughing wheel depicted in FIGS. 31-34, in accordance with the seventh embodiment of the present invention;

FIG. 36 is a perspective view of a third alternative polishing wheel, in accordance with an eighth embodiment of the present invention;

FIG. 37 is an elevational view of the third alternative polishing wheel depicted in FIG. 36, in accordance with the eighth embodiment of the present invention;

FIG. 38 is a top view of the third alternative polishing wheel depicted in FIGS. 36 and 37, in accordance with the eighth embodiment of the present invention;

FIG. 39 is a sectional plan view taken along line 39-39 of FIG. 37 of the third alternative polishing wheel depicted in FIGS. 36-38, in accordance with the eighth embodiment of the present invention;

FIG. 40 is a detailed side view illustrating the swarf-clearing groove of the third alternative polishing wheel depicted in FIGS. 36-39, in accordance with the eighth embodiment of the present invention;

FIG. 41 is a perspective view of a fourth alternative roughing wheel, in accordance with a ninth embodiment of the present invention;

FIG. 42 is an elevational view of the fourth alternative roughing wheel depicted in FIG. 41, in accordance with the ninth embodiment of the present invention;

FIG. 43 is a top view of the fourth alternative roughing wheel depicted in FIGS. 41 and 42, in accordance with the ninth embodiment of the present invention;

FIG. 44 is a sectional plan view taken along line 44-44 of FIG. 42 of the fourth alternative roughing wheel depicted in FIGS. 41-43, in accordance with the ninth embodiment of the present invention;

FIG. 45 is a detailed side view illustrating the swarf-clearing groove of the fourth alternative roughing wheel depicted in FIGS. 41-44, in accordance with the ninth embodiment of the present invention;

FIG. 46 is a perspective view of a fourth alternative polishing wheel, in accordance with a tenth embodiment of the present invention;

FIG. 47 is an elevational view of the fourth alternative polishing wheel depicted in FIG. 46, in accordance with the tenth embodiment of the present invention;

FIG. 48 is a top view of the fourth alternative polishing wheel depicted in FIGS. 46 and 47, in accordance with the tenth embodiment of the present invention;

FIG. 49 is a sectional plan view taken along line 49-49 of FIG. 47 of the fourth alternative polishing wheel depicted in FIGS. 46-48, in accordance with the tenth embodiment of the present invention;

FIG. 50 is a detailed side view illustrating the swarf-clearing groove of the fourth alternative polishing wheel depicted in FIGS. 46-49, in accordance with the tenth embodiment of the present invention;

FIG. 51 is a perspective view of a fifth alternative roughing wheel, in accordance with an eleventh embodiment of the present invention;

FIG. 52 is an elevational view of the fifth alternative roughing wheel depicted in FIG. 51, in accordance with the eleventh embodiment of the present invention;

FIG. 53 is a top view of the fifth alternative roughing wheel depicted in FIGS. 51 and 52, in accordance with the eleventh embodiment of the present invention;

FIG. 54 is a sectional plan view taken along line 54-54 of FIG. 52 of the fifth alternative roughing wheel depicted in FIGS. 51-53, in accordance with the eleventh embodiment of the present invention;

FIG. 55 is a detailed side view illustrating the swarf-clearing groove of the fifth alternative roughing wheel depicted in FIGS. 51-54, in accordance with the eleventh embodiment of the present invention;

FIG. 56 is a perspective view of a fifth alternative polishing wheel, in accordance with a twelfth embodiment of the present invention;

FIG. 57 is an elevational view of the fifth alternative polishing wheel depicted in FIG. 56, in accordance with the twelfth embodiment of the present invention;

FIG. 58 is a top view of the fifth alternative polishing wheel depicted in FIGS. 56 and 57, in accordance with the twelfth embodiment of the present invention;

FIG. 59 is a sectional plan view taken along line 59-59 of FIG. 57 of the fifth alternative polishing wheel depicted in FIGS. 56-58, in accordance with the twelfth embodiment of the present invention;

FIG. 60 is a detailed side view illustrating the swarf-clearing groove of the fifth alternative polishing wheel depicted in FIGS. 56-59, in accordance with the twelfth embodiment of the present invention;

FIG. 61 is a perspective view of a sixth alternative roughing wheel, in accordance with a thirteenth embodiment of the present invention;

FIG. 62 is an elevational view of the sixth alternative roughing wheel depicted in FIG. 61, in accordance with the thirteenth embodiment of the present invention;

FIG. 63 is a top view of the sixth alternative roughing wheel depicted in FIGS. 61 and 62, in accordance with the thirteenth embodiment of the present invention;

FIG. 64 is a sectional plan view taken along line 64-64 of FIG. 62 of the sixth alternative roughing wheel depicted in FIGS. 61-63, in accordance with the thirteenth embodiment of the present invention;

FIG. 65 is a detailed side view illustrating the swarf-clearing groove of the sixth alternative roughing wheel depicted in FIGS. 61-64, in accordance with the thirteenth embodiment of the present invention;

FIG. 66 is a perspective view of a sixth alternative polishing wheel, in accordance with a fourteenth embodiment of the present invention;

FIG. 67 is an elevational view of the sixth alternative polishing wheel depicted in FIG. 66, in accordance with the fourteenth embodiment of the present invention;

FIG. 68 is a top view of the sixth alternative polishing wheel depicted in FIGS. 66 and 67, in accordance with the fourteenth embodiment of the present invention;

FIG. 69 is a sectional plan view taken along line 69-69 of FIG. 67 of the sixth alternative polishing wheel depicted in FIGS. 66-68, in accordance with the fourteenth embodiment of the present invention;

FIG. 70 is a detailed side view illustrating the swarf-clearing groove of the sixth alternative polishing wheel depicted in FIGS. 66-69, in accordance with the fourteenth embodiment of the present invention;

FIG. 71 is a perspective view of a seventh alternative roughing wheel, in accordance with a fifteenth embodiment of the present invention;

FIG. 72 is an elevational view of the seventh alternative roughing wheel depicted in FIG. 71, in accordance with the fifteenth embodiment of the present invention;

FIG. 73 is a top view of the seventh alternative roughing wheel depicted in FIGS. 71 and 72, in accordance with the fifteenth embodiment of the present invention;

FIG. 74 is a sectional plan view taken along line 74-74 of FIG. 72 of the seventh alternative roughing wheel depicted in FIGS. 71-73, in accordance with the fifteenth embodiment of the present invention;

FIG. 75 is a detailed side view illustrating the swarf-clearing groove of the seventh alternative roughing wheel depicted in FIGS. 71-74, in accordance with the fifteenth embodiment of the present invention;

FIG. 76 is a perspective view of a seventh alternative polishing wheel, in accordance with a sixteenth embodiment of the present invention;

FIG. 77 is an elevational view of the seventh alternative polishing wheel depicted in FIG. 76, in accordance with the sixteenth embodiment of the present invention;

FIG. 78 is a top view of the seventh alternative polishing wheel depicted in FIGS. 76 and 77, in accordance with the sixteenth embodiment of the present invention;

FIG. 79 is a sectional plan view taken along line 79-79 of FIG. 77 of the seventh alternative polishing wheel depicted in FIGS. 76-78, in accordance with the sixteenth embodiment of the present invention;

FIG. 80 is a detailed side view illustrating the swarf-clearing groove of the seventh alternative polishing wheel depicted in FIGS. 76-79, in accordance with the sixteenth embodiment of the present invention;

FIG. 81 is a perspective view of an eighth alternative roughing wheel, in accordance with a seventeenth embodiment of the present invention;

FIG. 82 is an elevational view of the eighth alternative roughing wheel depicted in FIG. 81, in accordance with the seventeenth embodiment of the present invention;

FIG. 83 is a top view of the eighth alternative roughing wheel depicted in FIGS. 81 and 82, in accordance with the seventeenth embodiment of the present invention;

FIG. 84 is a sectional plan view taken along line 84-84 of FIG. 82 of the eighth alternative roughing wheel depicted in FIGS. 81-83, in accordance with the seventeenth embodiment of the present invention;

FIG. 85 is a detailed side view illustrating the swarf-clearing groove of the eighth alternative roughing wheel depicted in FIGS. 81-84, in accordance with the seventeenth embodiment of the present invention;

FIG. 86 is a perspective view of an eighth alternative polishing wheel, in accordance with an eighteenth embodiment of the present invention;

FIG. 87 is an elevational view of the eighth alternative polishing wheel depicted in FIG. 86, in accordance with the eighteenth embodiment of the present invention;

FIG. 88 is a top view of the eighth alternative polishing wheel depicted in FIGS. 86 and 87, in accordance with the eighteenth embodiment of the present invention;

FIG. 89 is a sectional plan view taken along line 89-89 of FIG. 87 of the eighth alternative polishing wheel depicted in FIGS. 86-88, in accordance with the eighteenth embodiment of the present invention;

FIG. 90 is a detailed side view illustrating the swarf-clearing groove of the eighth alternative polishing wheel depicted in FIGS. 86-89, in accordance with the eighteenth embodiment of the present invention;

FIG. 91 is a perspective view of a ninth alternative roughing wheel, in accordance with a nineteenth embodiment of the present invention;

FIG. 92 is an elevational view of the ninth alternative roughing wheel depicted in FIG. 91, in accordance with the nineteenth embodiment of the present invention;

FIG. 93 is a top view of the ninth alternative roughing wheel depicted in FIGS. 91 and 92, in accordance with the nineteenth embodiment of the present invention;

FIG. 94 is a sectional plan view taken along line 94-94 of FIG. 92 of the ninth alternative roughing wheel depicted in FIGS. 91-93, in accordance with the nineteenth embodiment of the present invention;

FIG. 95 is a detailed side view illustrating the swarf-clearing groove of the ninth alternative roughing wheel depicted in FIGS. 91-94, in accordance with the nineteenth embodiment of the present invention;

FIG. 96 is a perspective view of a ninth alternative polishing wheel, in accordance with a twentieth embodiment of the present invention;

FIG. 97 is an elevational view of the ninth alternative polishing wheel depicted in FIG. 96, in accordance with the twentieth embodiment of the present invention;

FIG. 98 is a top view of the ninth alternative polishing wheel depicted in FIGS. 96 and 97, in accordance with the tenth embodiment of the present invention;

FIG. 99 is a sectional plan view taken along line 99-99 of FIG. 97 of the ninth alternative polishing wheel depicted in FIGS. 96-98, in accordance with the tenth embodiment of the present invention; and

FIG. 100 is a detailed side view illustrating the swarf-clearing groove of the ninth alternative polishing wheel depicted in FIGS. 96-99, in accordance with the twentieth embodiment of the present invention.

The same reference numerals refer to the same parts throughout the various Figures.

### DETAILED DESCRIPTION OF THE PREFERRED EMBODIMENTS

Although the following description primary concerns rough cutting and polishing wheels for use with optical lens blanks, it should be appreciated that the present invention can be practiced with any type of surfacing wheel wherein removal of swarf material is desirable. For example, the present invention can be applied to any number of types of surfacing wheels, such as but not limited to rough cutting wheels, fine grinding wheels, finishing wheels, polishing wheels, beveling wheels, and the like. Additionally, the present invention can be practiced with any type of optical lens blank material, such but not limited to polycarbonates and high index plastics, as well as those materials currently marketed under the trade names CR39® and TRIVEX™.

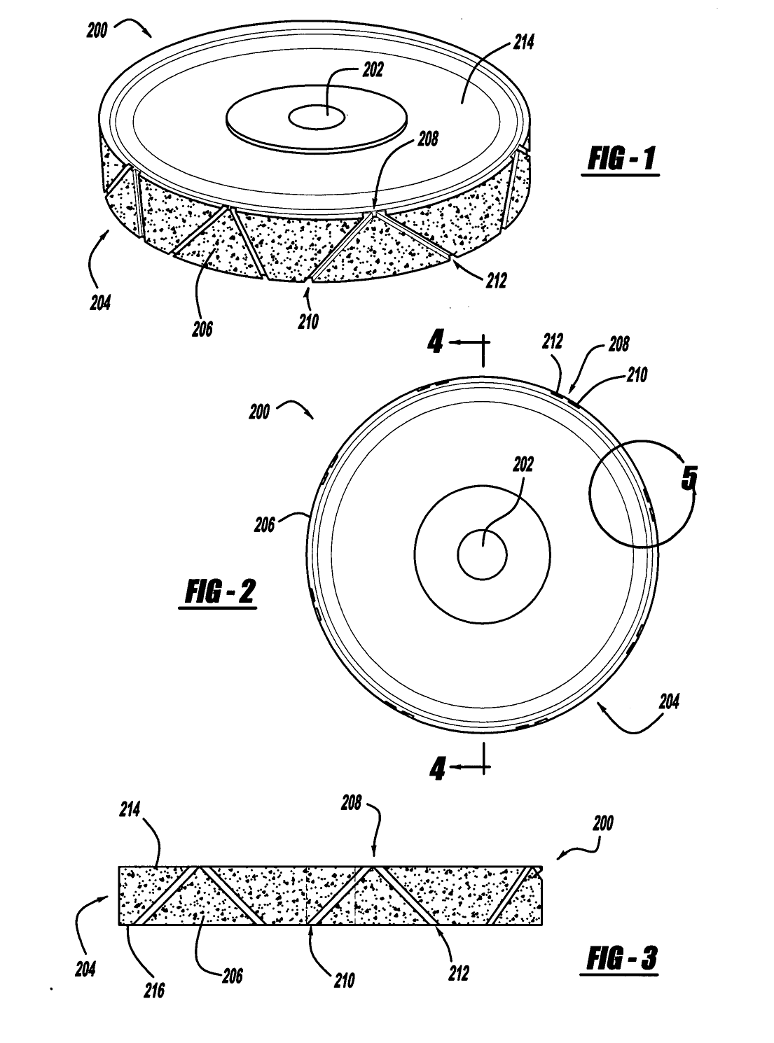

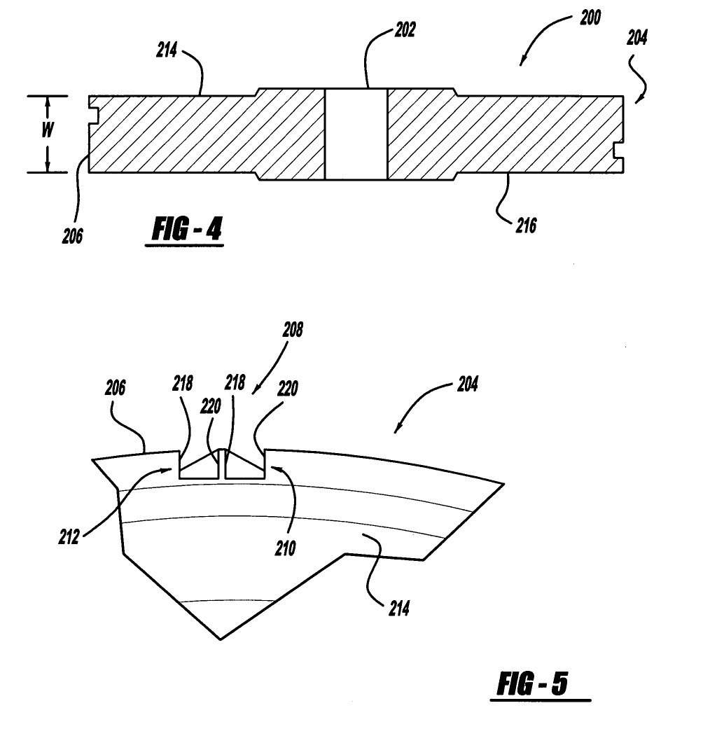

In accordance with a first embodiment of the present invention, there is provided a rough cutting wheel generally shown at 200 for rough cutting of an optical lens, as shown in FIGS. 1-5. The rough cutting wheel 200 preferably includes a hub portion generally indicated at 202 and an outer circumferential cutting surface generally indicated at 204. The cutting surface 204 includes a width W and includes an abrasive grit material 206 that is preferably attached thereto for rough cutting of the lens.

The exact grit rating of the abrasive grit material 206 is not thought to be critical to the success of the present invention, provided that the abrasive grit material 206 of the present invention is operable to rough cut any conventional optical lens materials, such as but not limited to polycarbonates and high index plastics, as well as those materials currently marketed under the trade names CR39® and TRIVEX™. In accordance with a preferred embodiment of the present invention, the grit rating of the abrasive grit material 206 is preferably in the range of about 20 to about 80, more preferably in the range of about 60 to about 80, and still more preferably in the range of about 60 to about 70. It should be appreciated that grit rating outside of these ranges, i.e., less than 20 and/or greater than 80, may be used as well in the practice of the present invention, should circumstances require (e.g., material specific requirements).

Preferably, the abrasive grit material 206 is attached by brazing the abrasive grit onto the cutting surface 204 of the wheel 200. However, the abrasive grit material 206 may also be attached to the cutting surface 204 by sintering electroplating or resin bonding. The abrasive grit material 206 is preferably comprised of a diamond-like hardness abrasive grit. However, other materials such as silicon carbides, tungsten carbides, oxides, garnets, cubic boron nitride, and natural and synthetic diamonds may be used alone or in combination in the present invention.

In accordance with a preferred embodiment of the present invention, the wheel 200 includes at least one pair 208 of substantially adjacent swarf-clearing clearing grooves 210, 212, respectively, that extend across the width W of the surface cutting 204, i.e., are contiguous from a first outer planar surface 214 to a second spaced and opposed outer planar surface 216 of the wheel 200. The grooves 210, 212, respectively, preferably form a chevron or chevron-like configuration.

By “pair,” as that term is used herein, it is meant two or more swarf-clearing grooves. By “adjacent,” as that term is used herein, it is meant two or more swarf-clearing grooves that are in relative proximity to one another. It should be appreciated that several and/or a plurality of pairs of adjacent swarf-clearing grooves may be employed in the practice of the present invention. The intended purpose of the swarf-clearing grooves 210, 212, respectively, is for removal or swarf during rough cutting of the lens.

The exact dimensions of the grooves 210, 212, respectively, are not thought to be critical to the success of the present invention provided that they do not hamper the swarf removal process. In accordance with a preferred embodiment of the present invention, the width and/or depth of either of the grooves 210, 212, respectively, is in the range of about 1 about 10 millimeters. In accordance with a preferred embodiment of the present invention, the length of either of the grooves 210, 212, respectively, is in the range of about 1 about 35 and preferably 20-30 millimeters. However, it should be appreciated that the width, depth, and/or length of the grooves of the present invention can be modified without departing from the scope of the present invention.

In accordance with a preferred embodiment of the present invention, multiple numbers of grooves are employed in the practice of the present invention. In accordance with a more preferred embodiment of the present invention, at least two to at least twenty grooves can be employed. In accordance with a highly preferred embodiment of the present invention, at least six to at least sixteen grooves are employed.

The exact spacing and distribution of the grooves 210, 212, respectively, are not thought to be critical to the success of the present invention provided that they do not hamper the swarf removal process. In accordance with a preferred embodiment of the present invention, about one-half to about three grooves are provided for per inch of the cutting surface 204.

In accordance with a preferred embodiment of the present invention, the surface area of the wheel that comprises the groove area is preferably in the range of about 6% to about 60%, and more preferably in the range of about 20% to about 30%.

The grooves 210, 212, are preferably configured so as to be either angled towards and/or angled away from one another. By way of a non-limiting example, each of the grooves 210, 212, respectively, can be angled from about 20 degrees to about 165 degrees in relation to either outer planar surface 214, 216, respectively. In accordance with a preferred embodiment of the present invention, each of the grooves 210, 212, respectively, can be angled from about 1 degree to about 89 degrees and/or from about 91 degrees to about 179 degrees in relation to either outer planar surface 214, 216, respectively. In accordance with a more preferred embodiment of the present invention, each of the grooves 210, 212, respectively, can be angled from about 70 degrees to about 100 degrees in relation to either outer planar surface 214, 216, respectively.

In accordance with a preferred embodiment of the present invention, each of the grooves 210, 212, respectively, can be angled from about 10 degrees to about 80 degrees in relation to either outer planar surface 214, 216, respectively. In accordance with a more preferred embodiment of the present invention, each of the grooves 210, 212, respectively, can be angled from about 15 degrees to about 65 degrees in relation to either outer planar surface 214, 216, respectively. In accordance with a highly preferred embodiment of the present invention, each of the grooves 210, 212, respectively, can be angled from about 35 degrees to about 45 degrees in relation to either outer planar surface 214, 216, respectively.

Regardless of the angle chosen, each groove 210, 212, respectively, should preferably have the same angle, e.g., if groove 210 is angled 45 degrees away from outer planar surface 214, then groove 212 should also be angled 45 degrees away from outer planar surface 214 in the same and/or opposite orientation. In accordance with a preferred embodiment of the present invention, each groove is a mirror image of the other spaced and opposed groove.

Each of the grooves 210, 212, respectively, preferably has planar sides 218, 220, respectively, that extend substantially perpendicular to either outer planar surfaces 214, 216, respectively.

Rough cutting wheels made in accordance with the present invention are readily used in rough cutting, finishing, and/or polishing machines such as those made by Wernicke & Company (Concord, Canada), Brio, Essilor, Nidek, and Indo, for example. Such machines are readily known to those skilled in the art, as well as their operation.

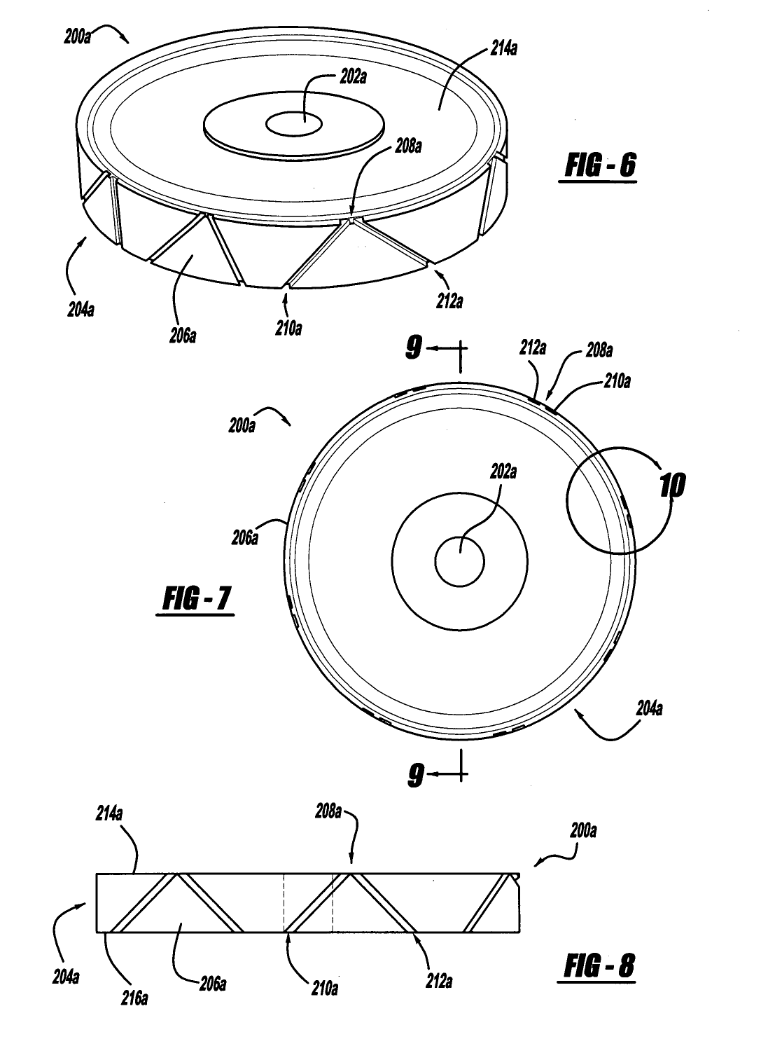

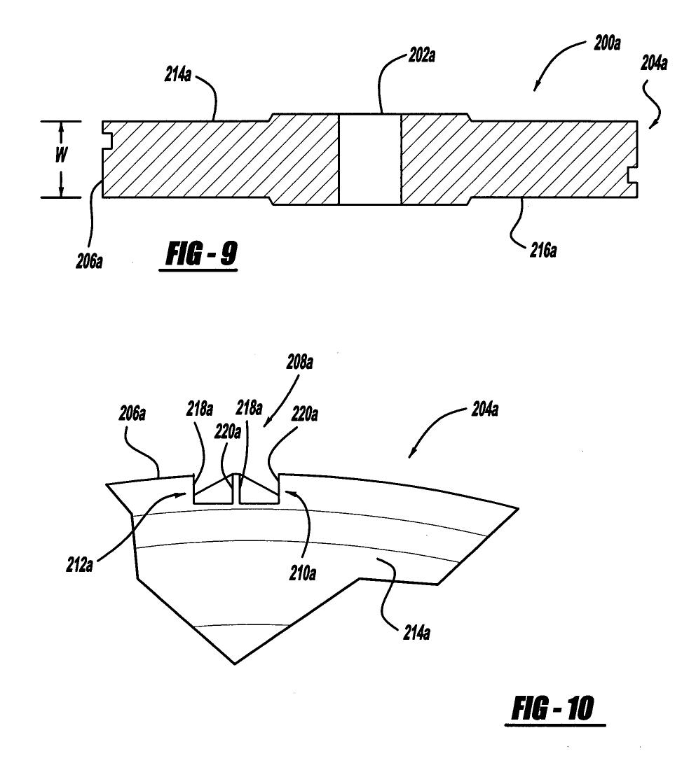

In accordance with a second embodiment of the present invention, there is provided a polishing wheel generally shown at 200a for polishing of an optical lens, as shown in FIGS. 6-10. Again, the intended purpose of the polishing wheel 200a is to, among other things, facilitate the removal of swarf material.

The polishing wheel 200a is similar to the rough cutting wheel 200 shown in FIGS. 1-5, e.g., it includes a hub portion 202a, an outer circumferential cutting surface 204a (having a width W), an abrasive grit material 206a, at least one pair 208a of substantially adjacent swarf-clearing grooves 210a, 212a, respectively, that extend across the width W of the cutting surface 204a, i.e., are contiguous from a first outer planar surface 214a to a second spaced and opposed outer planar surface 216a of the wheel 200a, wherein each of the grooves 210a, 212a, respectively, preferably has planar sides 218a, 220a, respectively, that extend substantially perpendicular to either outer planar surfaces 214a, 216a, respectively.

However, because the polishing wheel 200a is intended for fine grinding and/or polishing of the optical lens, it is instead preferred to use an abrasive grit material that is much finer and thus less abrasive than the abrasive grit material 206 used for the rough cutting wheel 200. In accordance with a preferred embodiment of the present invention, the grit rating of the abrasive grit material 206a is preferably in the range of about 80 to about 600. It should be appreciated that grit rating outside of these ranges, i.e., less than 80 and/or greater than 600, may be used as well in the practice of the present invention, should circumstances require (e.g., material specific requirements).

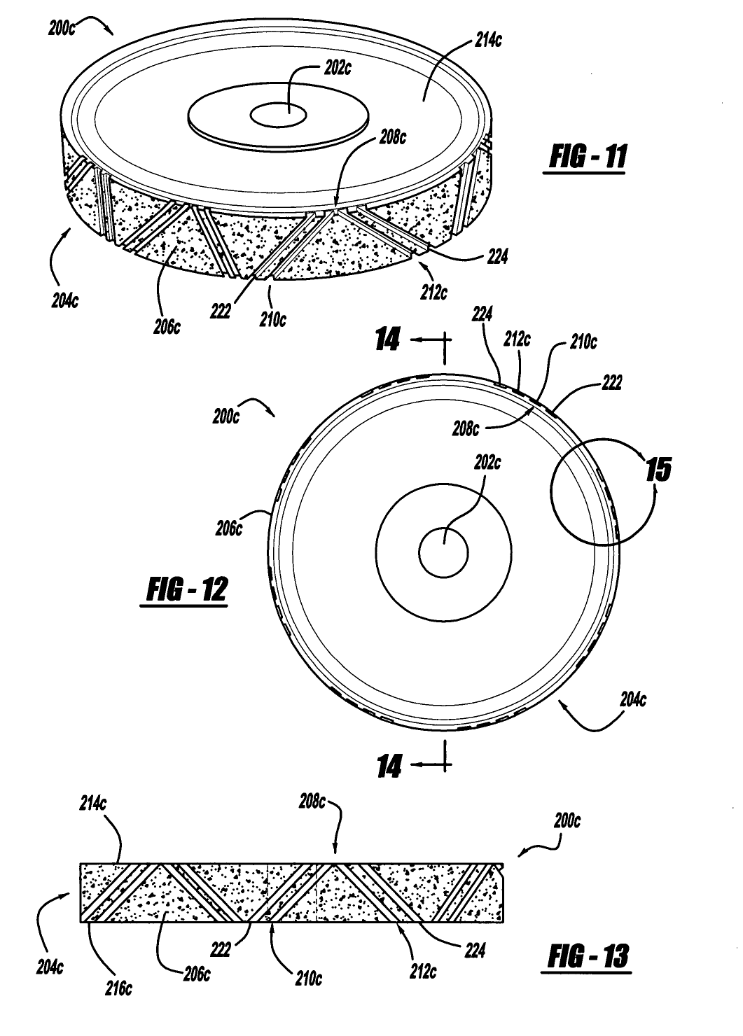

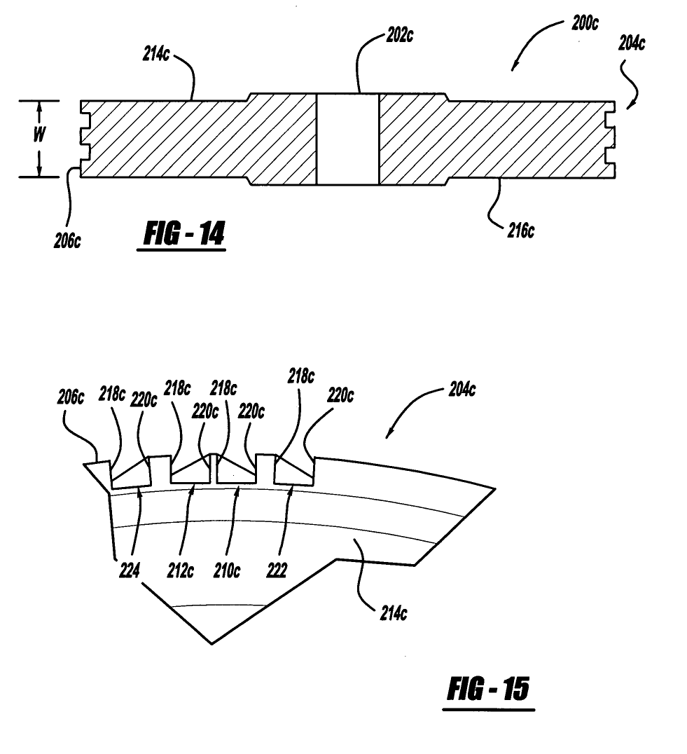

In accordance with a third embodiment of the present invention, there is provided a first alternative rough cutting wheel generally shown at 200c for rough cutting of an optical lens, as shown in FIGS. 11-15. Again, the intended purpose of the rough cutting wheel 200c is to, among other things, facilitate the removal of swarf material.

The rough cutting wheel 200c is similar to the rough cutting wheel 200 shown in FIGS. 1-5, e.g., it includes a hub portion 202c, an outer circumferential cutting surface 204c (having a width W), an abrasive grit material 206c, at least one pair 208c of substantially adjacent swarf-clearing grooves 210c, 212c, respectively, that extend across the width W of the cutting surface 204c, i.e., are contiguous from a first outer planar surface 214c to a second spaced and opposed outer planar surface 216c of the wheel 200c, wherein each of the grooves 210c, 212c, respectively, preferably has planar sides 218c, 220c, respectively, that extend substantially perpendicular to either outer planar surfaces 214c, 216c, respectively.

However, this embodiment differs in that two additional swarf-clearing grooves 222 and 224, respectively are provided in proximity to grooves 210c, 212c, respectively.

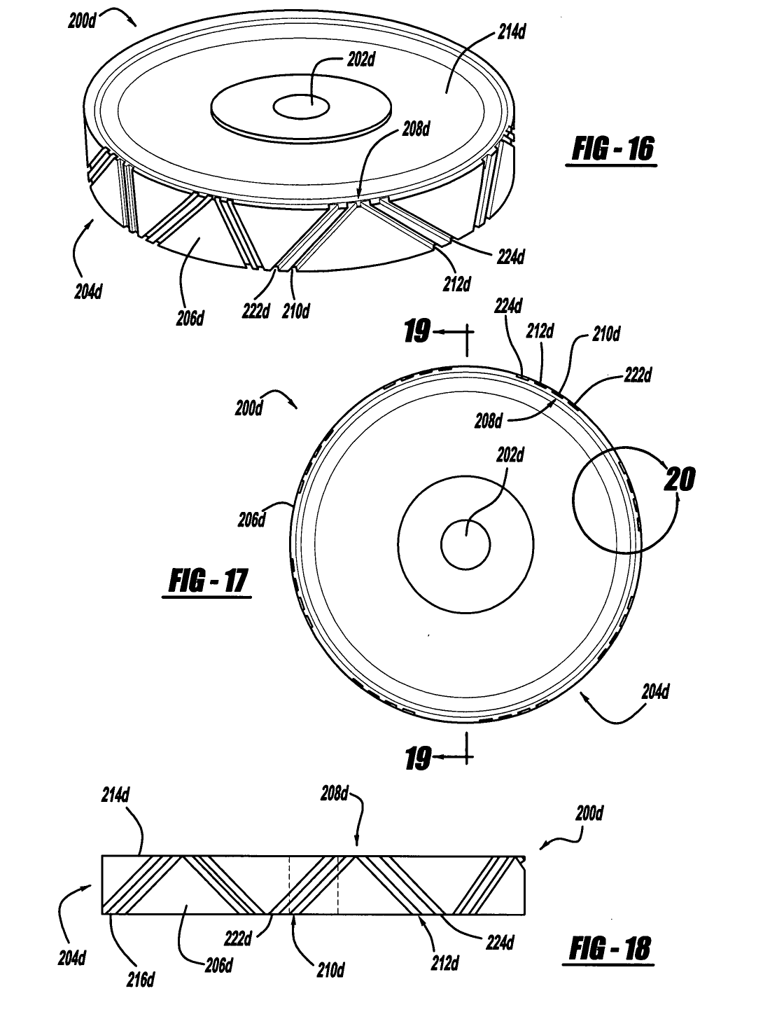

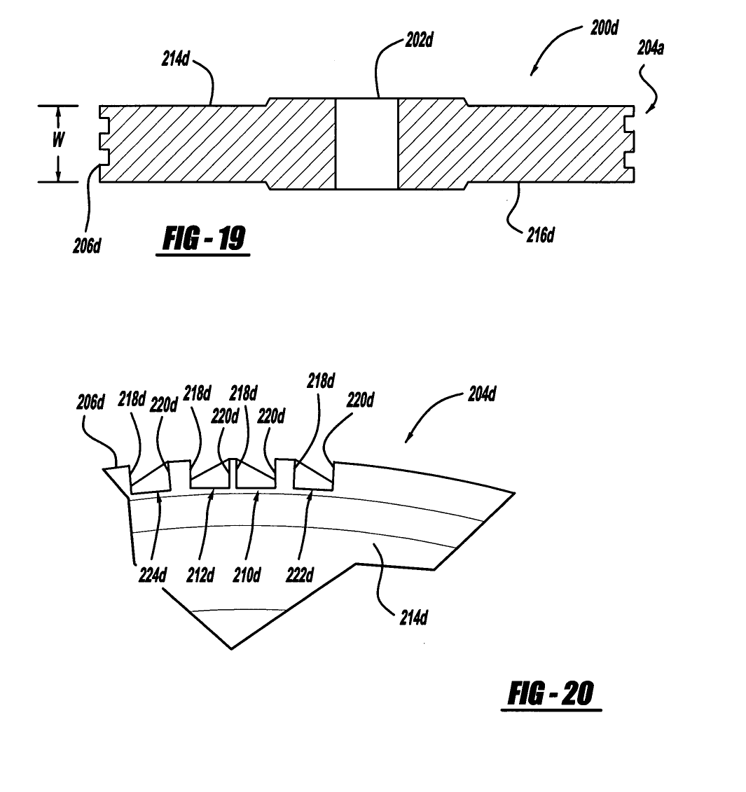

In accordance with a fourth embodiment of the present invention, there is provided a first alternative polishing wheel generally shown at 200d for polishing of an optical lens, as shown in FIGS. 16-20. Again, the intended purpose of the polishing wheel 200d is to, among other things, facilitate the removal of swarf material.

The polishing wheel 200d is similar to the rough cutting wheel 200c shown in FIGS. 11-15, e.g., it includes a hub portion 202d, an outer circumferential cutting surface 204d (having a width W), an abrasive grit material 206d, at least one pair 208d of substantially adjacent swarf-clearing grooves 210d, 212d, 222d, 224d, respectively, that extend across the width W of the cutting surface 204d, i.e., are contiguous from a first outer planar surface 214d to a second spaced and opposed outer planar surface 216d of the wheel 200d, wherein each of the grooves 210d, 212d, 222d, 224d, respectively, preferably has planar sides 218d, 220d, respectively, that extend substantially perpendicular to either outer planar surfaces 214d, 216d, respectively.

However, as with the embodiment shown in FIGS. 6-10, because the polishing wheel 200d is intended for fine grinding and/or polishing of the optical lens, it is instead preferred to use an abrasive grit material that is much finer and thus less abrasive than the abrasive grit material 206 used for the rough cutting wheel 200. In accordance with a preferred embodiment of the present invention, the grit rating of the abrasive grit material 206d is preferably in the range of about 80 to about 600. It should be appreciated that grit rating outside of these ranges, i.e., less than 80 and/or greater than 600, may be used as well in the practice of the present invention, should circumstances require (e.g., material specific requirements).

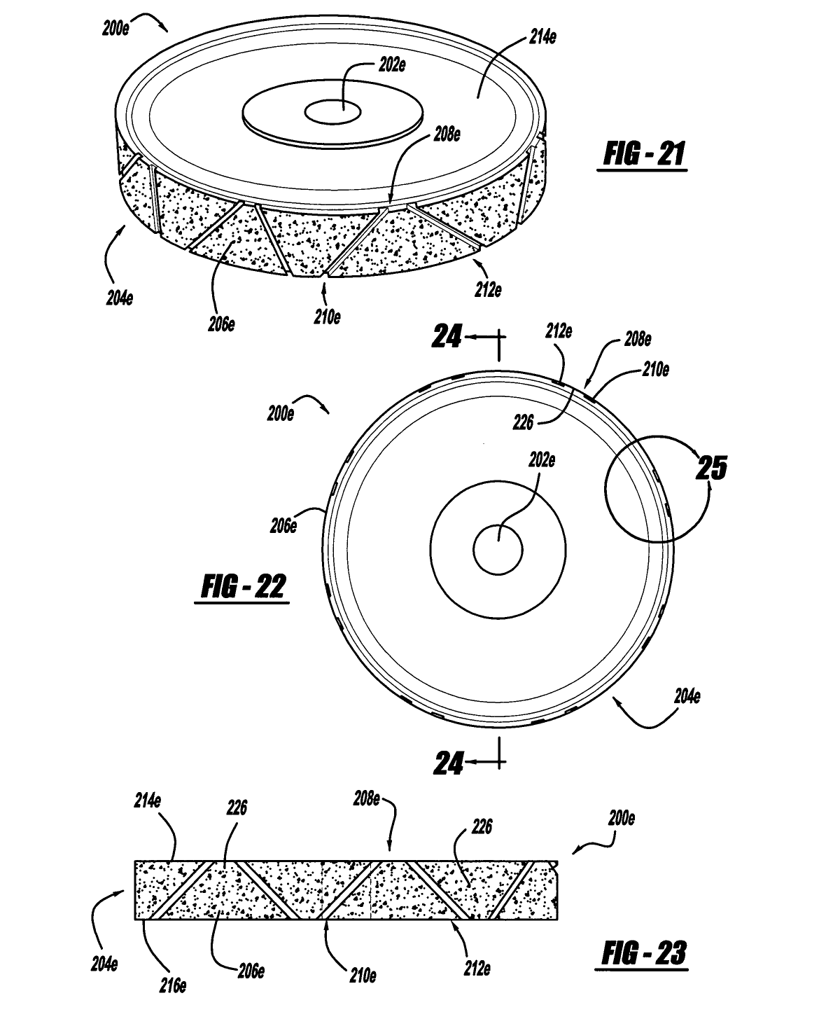

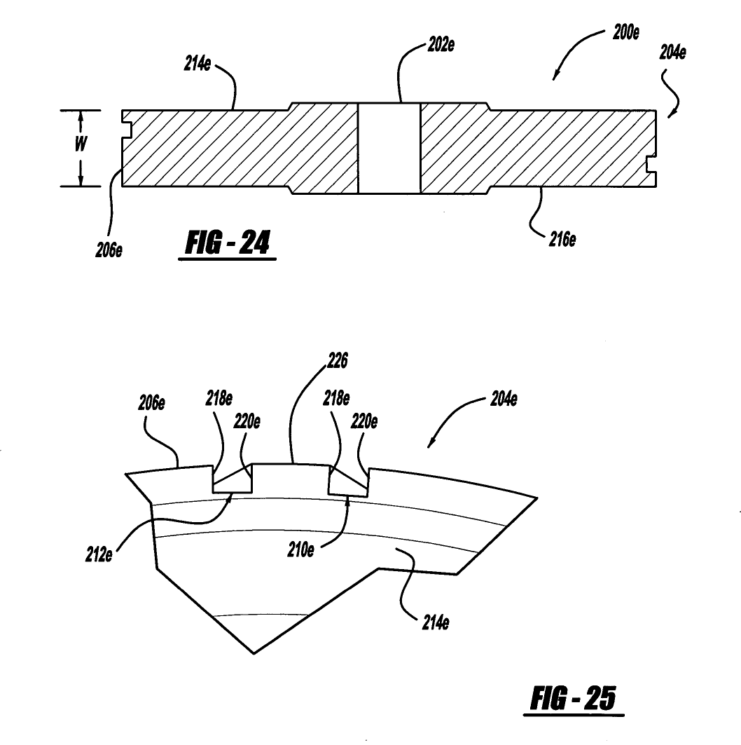

In accordance with a fifth embodiment of the present invention, there is provided a second alternative rough cutting wheel generally shown at 200e for rough cutting of an optical lens, as shown in FIGS. 21-25. Again, the intended purpose of the rough cutting wheel 200e is to, among other things, facilitate the removal of swarf material.

The rough cutting wheel 200e is similar to the rough cutting wheel 200 shown in FIGS. 1-5, e.g., it includes a hub portion 202e, an outer circumferential cutting surface 204e (having a width W), an abrasive grit material 206e, at least one pair 208e of substantially adjacent swarf-clearing grooves 210e, 212e, respectively, that extend across the width W of the cutting surface 204e, i.e., are contiguous from a first outer planar surface 214e to a second spaced and opposed outer planar surface 216e of the wheel 200e, wherein each of the grooves 210e, 212e, respectively, preferably has planar sides 218e, 220e, respectively, that extend substantially perpendicular to either outer planar surfaces 214e, 216e, respectively.

However, in this embodiment the respective grooves, 210e, 212e have been configured such that a space or gap 226 has been created between the respective grooves 210e, 212e.

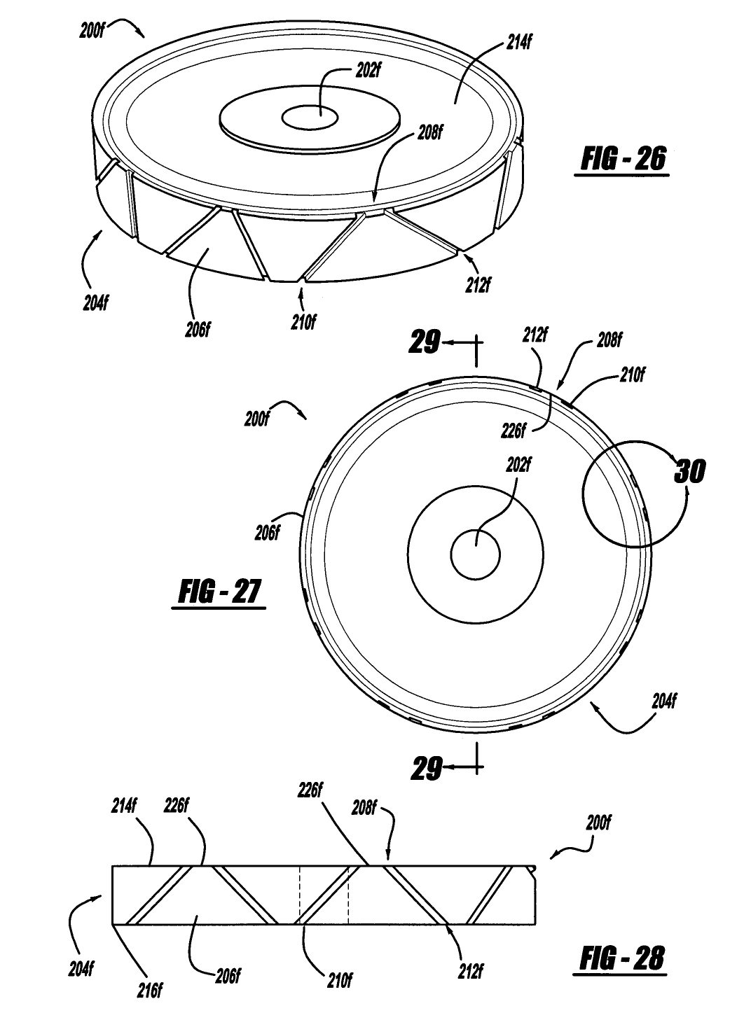

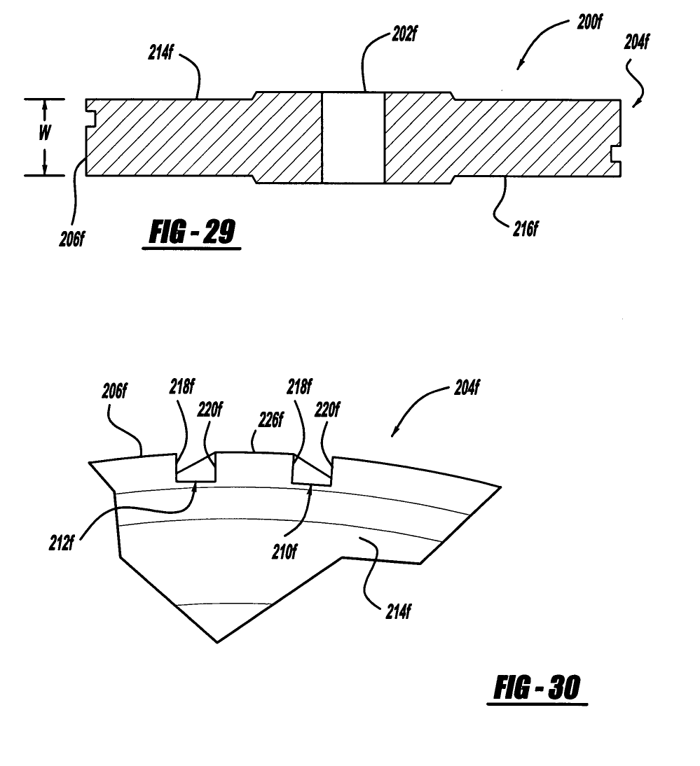

In accordance with a sixth embodiment of the present invention, there is provided a second alternative polishing wheel generally shown at 200f for polishing of an optical lens, as shown in FIGS. 26-30. Again, the intended purpose of the polishing wheel 200f is to, among other things, facilitate the removal of swarf material.

The polishing wheel 200f is similar to the rough cutting wheel 200e shown in FIGS. 21-25, e.g., it includes a hub portion 202f, an outer circumferential cutting surface 204f (having a width W), an abrasive grit material 206f, at least one pair 208f of substantially adjacent swarf-clearing grooves 210f, 212f, respectively, that extend across the width W of the cutting surface 204f, i.e., are contiguous from a first outer planar surface 214f to a second spaced and opposed outer planar surface 216f of the wheel 200f, wherein each of the grooves 210f, 212f, respectively, preferably has planar sides 218f, 220f, respectively, that extend substantially perpendicular to either outer planar surfaces 214f, 216f, respectively, and a gap 226f formed between the respective grooves 21 of, 212f.

However, as with the embodiment shown in FIGS. 6-10 and 16-20, because the polishing wheel 200f is intended for fine grinding and/or polishing of the optical lens, it is instead preferred to use an abrasive grit material that is much finer and thus less abrasive than the abrasive grit material 206 used for the rough cutting wheel 200. In accordance with a preferred embodiment of the present invention, the grit rating of the abrasive grit material 206f is preferably in the range of about 80 to about 600. It should be appreciated that grit rating outside of these ranges, i.e., less than 80 and/or greater than 600, may be used as well in the practice of the present invention, should circumstances require (e.g., material specific requirements).

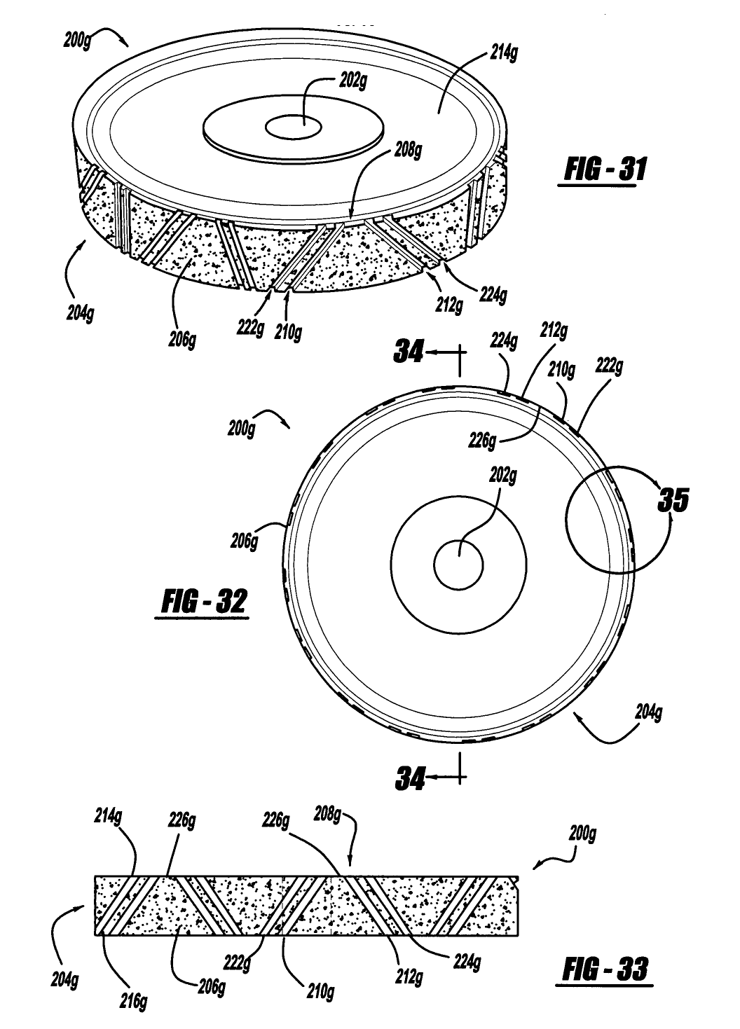

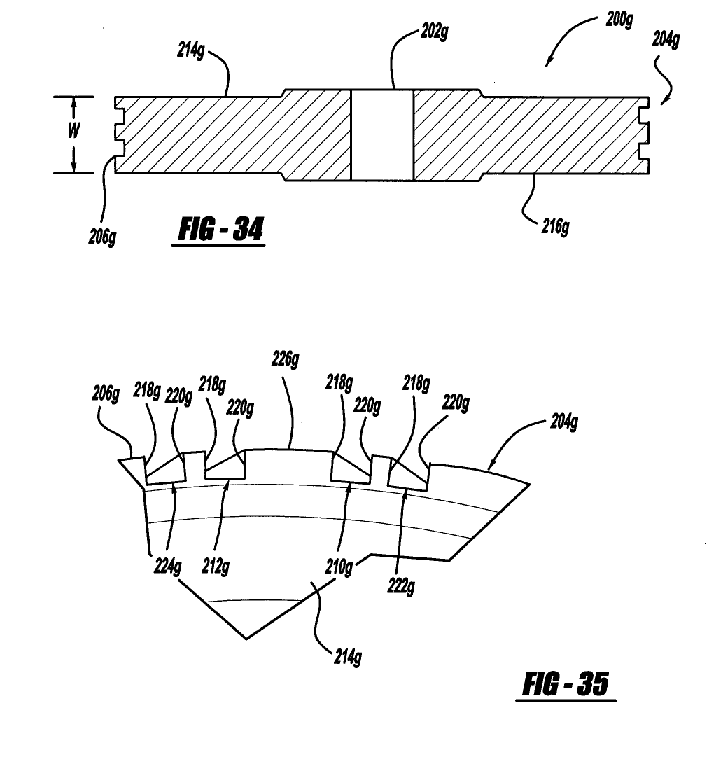

In accordance with a seventh embodiment of the present invention, there is provided a third alternative rough cutting wheel generally shown at 200g for rough cutting of an optical lens, as shown in FIGS. 31-35. Again, the intended purpose of the rough cutting wheel 200g is to, among other things, facilitate the removal of swarf material.

The rough cutting wheel 200g is similar to the rough cutting wheel 200e shown in FIGS. 21-25, e.g., it includes a hub portion 202g, an outer circumferential cutting surface 204g (having a width W), an abrasive grit material 206g, at least one pair 208g of substantially adjacent swarf-clearing grooves 210g, 212g, respectively, that extend across the width W of the cutting surface 204g, i.e., are contiguous from a first outer planar surface 214g to a second spaced and opposed outer planar surface 216g of the wheel 200g, wherein each of the grooves 210g, 212g, respectively, preferably has planar sides 218g, 220g, respectively, that extend substantially perpendicular to either outer planar surfaces 214g, 216g, respectively, and a gap 226g formed between the respective grooves 210g, 212g.

However, this embodiment differs in that two additional swarf-clearing grooves 222g and 224g respectively are provided in proximity to grooves 210g, 212g, respectively.

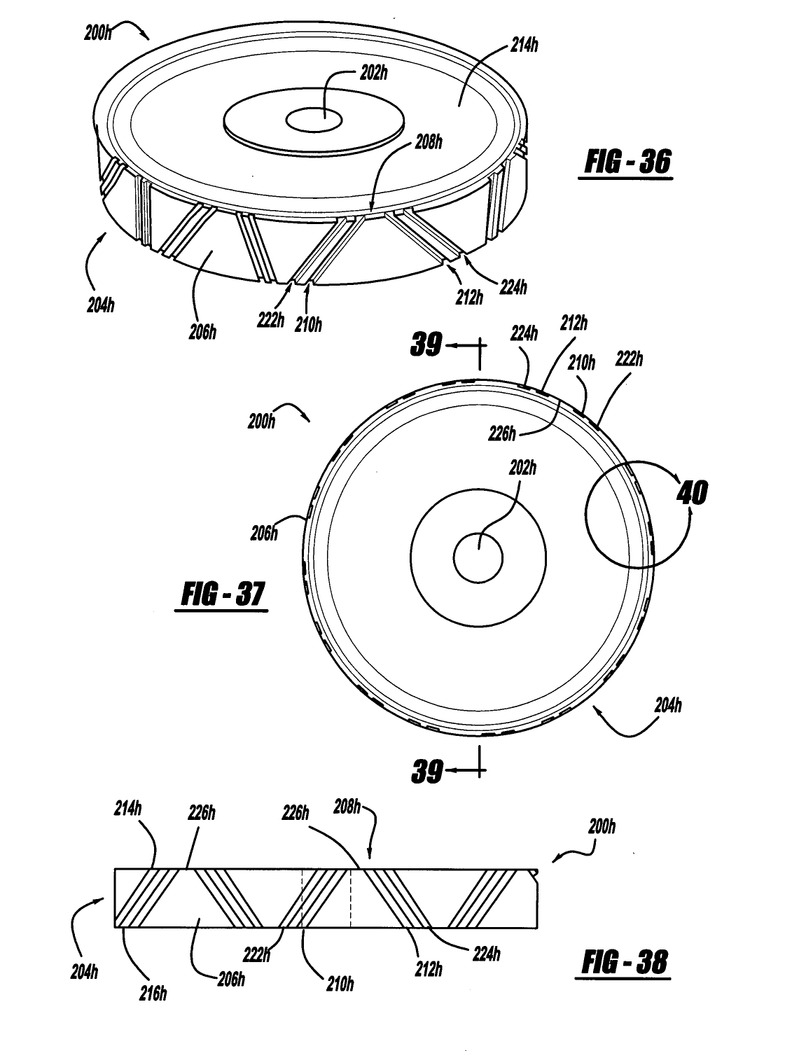

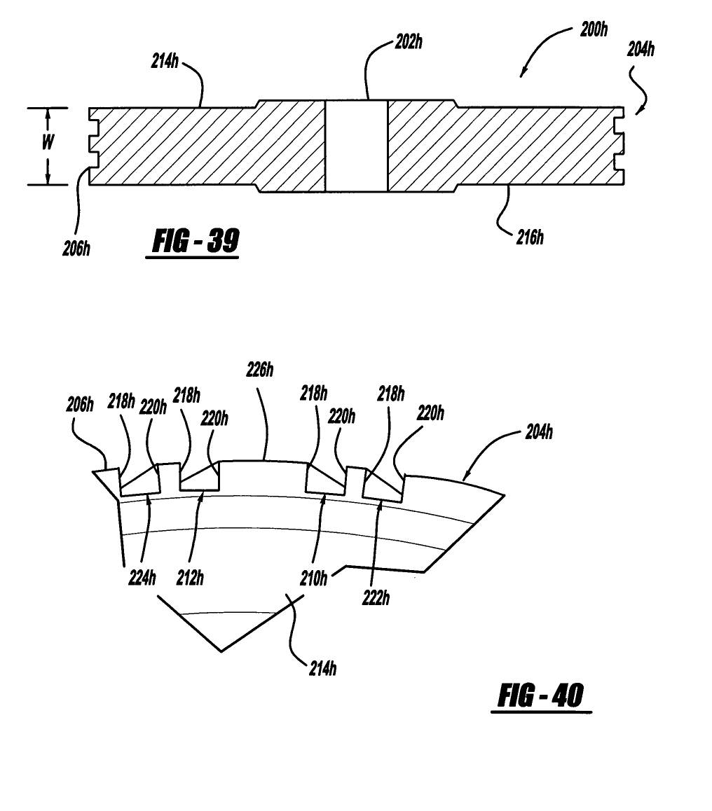

In accordance with an eighth embodiment of the present invention, there is provided a third alternative polishing wheel generally shown at 200h for polishing of an optical lens, as shown in FIGS. 36-40. Again, the intended purpose of the polishing wheel 200h is to, among other things, facilitate the removal of swarf material.

The polishing wheel 200h is similar to the rough cutting wheel 200g shown in FIGS. 31-35, e.g., it includes a hub portion 202h, an outer circumferential cutting surface 204h (having a width W), an abrasive grit material 206h, at least one pair 208h of substantially adjacent swarf-clearing grooves 210h, 212h, 222h, 224h, respectively, that extend across the width W of the cutting surface 204h, i.e., are contiguous from a first outer planar surface 214h to a second spaced and opposed outer planar surface 216h of the wheel 200h, wherein each of the grooves 21 Oh, 212h, 222h, 224h, respectively, preferably has planar sides 218h, 220h, respectively, that extend substantially perpendicular to either outer planar surfaces 214h, 216h, respectively.

However, as with the embodiment shown in FIGS. 6-10, because the polishing wheel 200h is intended for fine grinding and/or polishing of the optical lens, it is instead preferred to use an abrasive grit material that is much finer and thus less abrasive than the abrasive grit material 206 used for the rough cutting wheel 200. In accordance with a preferred embodiment of the present invention, the grit rating of the abrasive grit material 206h is preferably in the range of about 80 to about 600. It should be appreciated that grit rating outside of these ranges, i.e., less than 80 and/or greater than 600, may be used as well in the practice of the present invention, should circumstances require (e.g., material specific requirements).

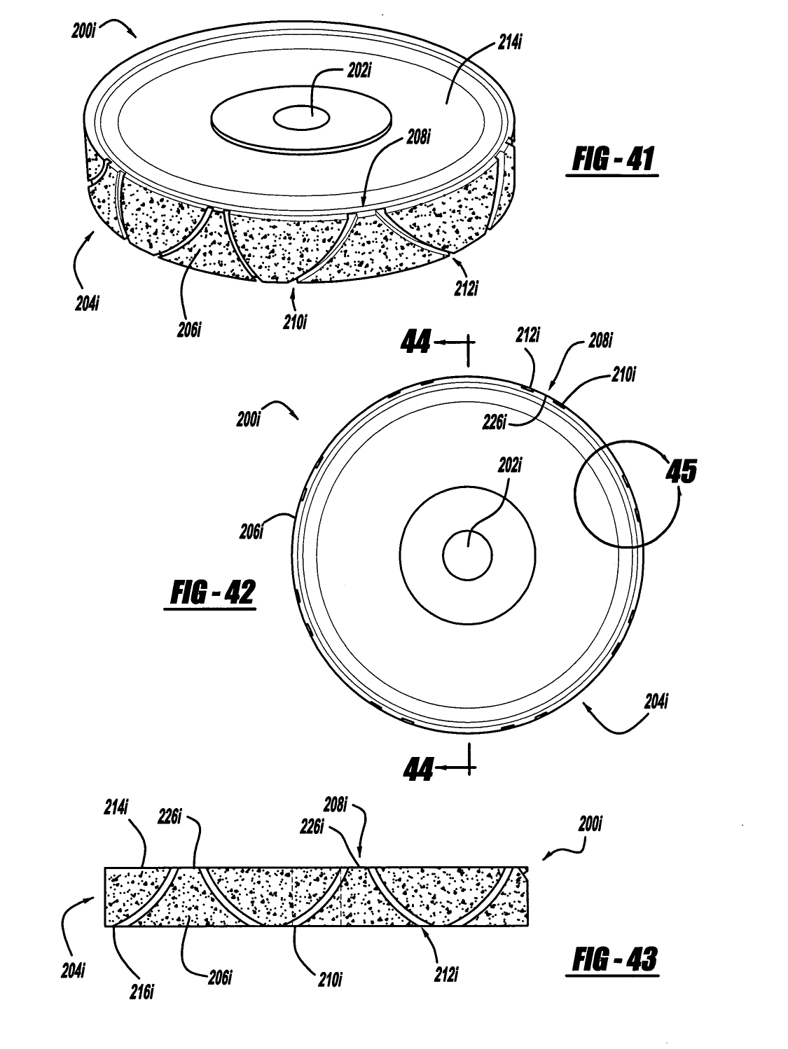

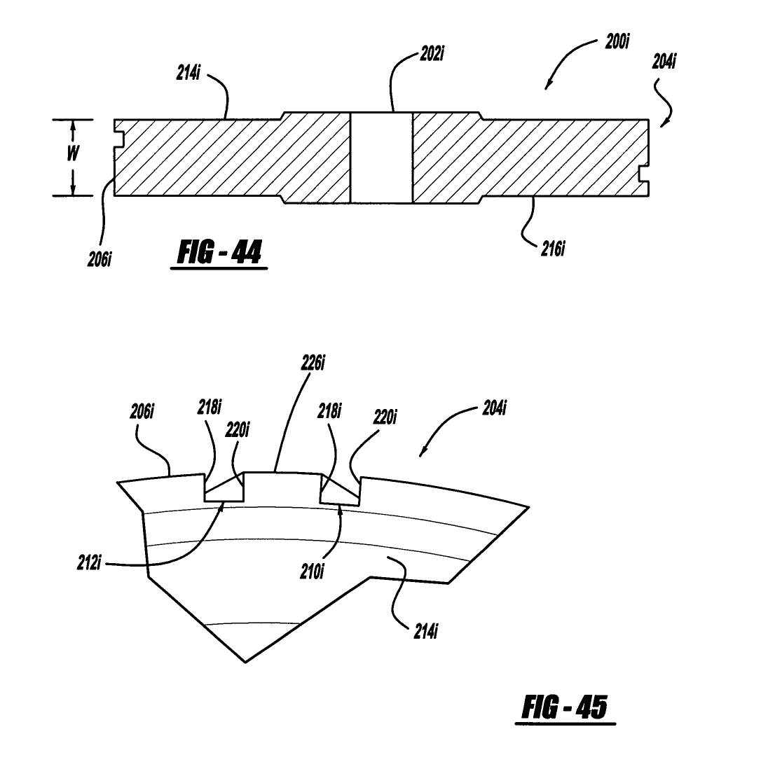

In accordance with a ninth embodiment of the present invention, there is provided a fourth alternative rough cutting wheel generally shown at 200i for rough cutting of an optical lens, as shown in FIGS. 41-45. Again, the intended purpose of the rough cutting wheel 200i is to, among other things, facilitate the removal of swarf material.

The rough cutting wheel 200i is similar to the rough cutting wheel 200e shown in FIGS. 21-25, e.g., it includes a hub portion 202i, an outer circumferential cutting surface 204i (having a width W), an abrasive grit material 206i, at least one pair 208i of substantially adjacent swarf-clearing grooves 210i, 212i, respectively, that extend across the width W of the cutting surface 204i, i.e., are contiguous from a first outer planar surface 214i to a second spaced and opposed outer planar surface 216i of the wheel 200i, wherein each of the grooves 210i, 212i, respectively, preferably has planar sides 218i, 220i, respectively, that extend substantially perpendicular to either outer planar surfaces 214i, 216i, respectively, and an optional gap 226i formed between the respective grooves 210i, 212i.

However, this embodiment differs in that the grooves 210i and 212i, respectively, are curved with respect to either outer planar surfaces 214i, 216i, respectively. The exact degree and/or direction of curvature is not thought to be critical to the success of the present invention, provided it does not hamper the swarf removal process.

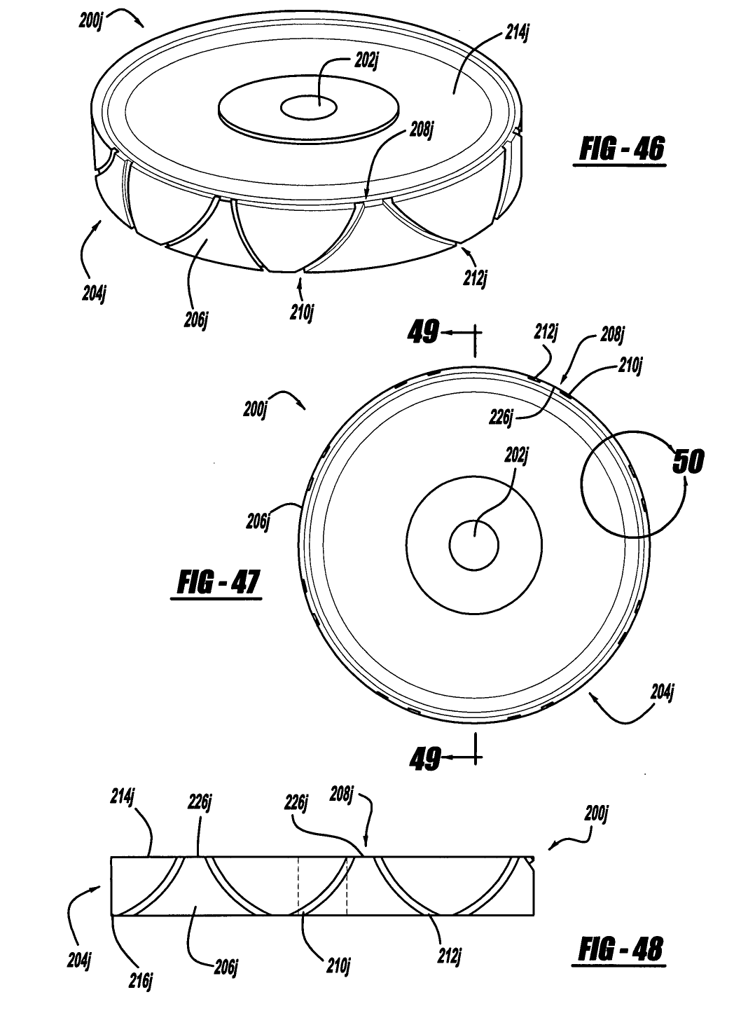

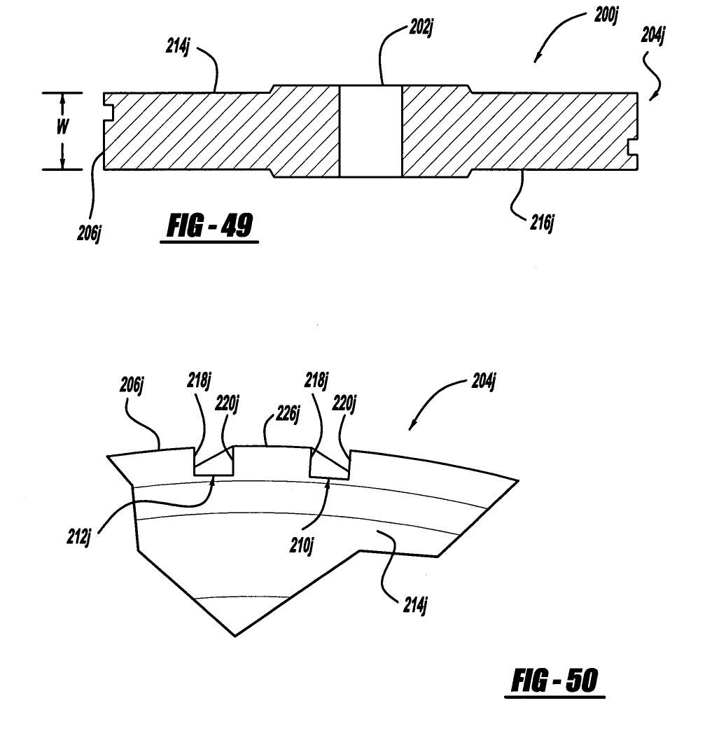

In accordance with a tenth embodiment of the present invention, there is provided a fourth alternative polishing wheel generally shown at 200j for polishing of an optical lens, as shown in FIGS. 46-50. Again, the intended purpose of the polishing wheel 200j is to, among other things, facilitate the removal of swarf material.

The polishing wheel 200j is similar to the rough cutting wheel 200i shown in FIGS. 41-45, e.g., it includes a hub portion 202j, an outer circumferential cutting surface 204j (having a width W), an abrasive grit material 206j, at least one pair 208j of substantially adjacent curved swarf-clearing grooves 210j, 212j, respectively, that extend across the width W of the cutting surface 204j, i.e., are contiguous from a first outer planar surface 214j to a second spaced and opposed outer planar surface 216j of the wheel 200j, wherein each of the curved grooves 210j, 212j, respectively, preferably has planar sides 218j, 220j, respectively, that extend substantially perpendicular to either outer planar surfaces 214j, 216j, respectively, and an optional gap 226j formed between the respective grooves 210j, 212j.

However, as with the embodiment shown in FIGS. 6-10, because the polishing wheel 200j is intended for fine grinding and/or polishing of the optical lens, it is instead preferred to use an abrasive grit material that is much finer and thus less abrasive than the abrasive grit material 206 used for the rough cutting wheel 200. In accordance with a preferred embodiment of the present invention, the grit rating of the abrasive grit material 206j is preferably in the range of about 80 to about 600. It should be appreciated that grit rating outside of these ranges, i.e., less than 80 and/or greater than 600, may be used as well in the practice of the present invention, should circumstances require (e.g., material specific requirements).

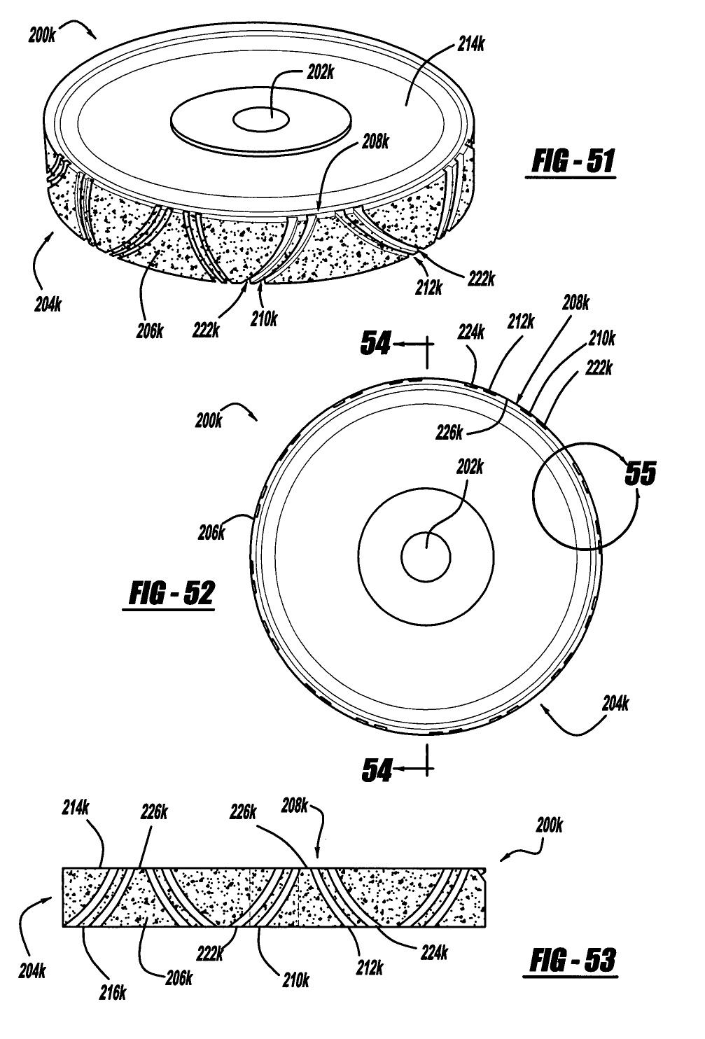

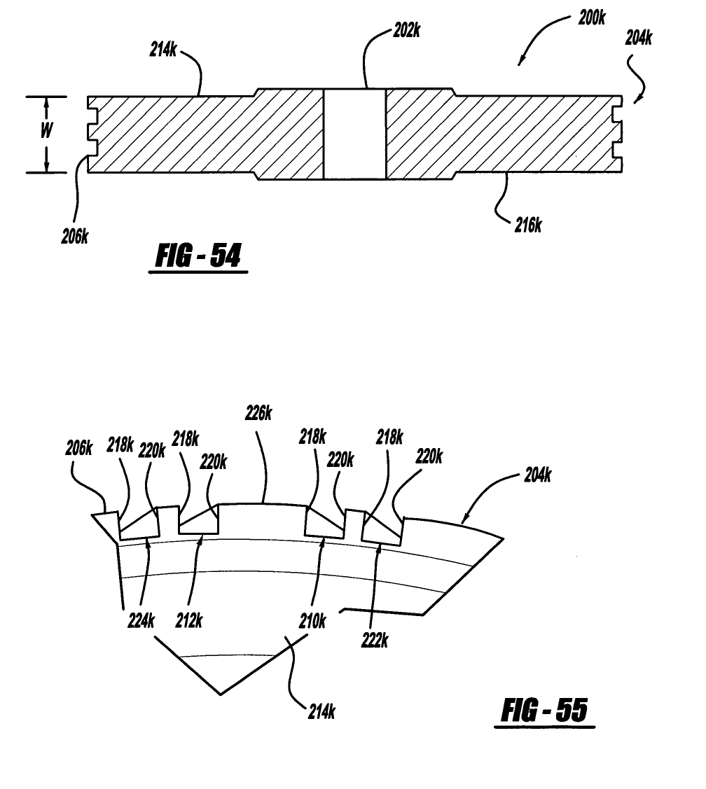

In accordance with an eleventh embodiment of the present invention, there is provided a fifth alternative rough cutting wheel generally shown at 200k for rough cutting of an optical lens, as shown in FIGS. 51-55. Again, the intended purpose of the rough cutting wheel 200k is to, among other things, facilitate the removal of swarf material.

The rough cutting wheel 200k is similar to the rough cutting wheel 200i shown in FIGS. 41-45, e.g., it includes a hub portion 202k, an outer circumferential cutting surface 204k (having a width W), an abrasive grit material 206k, at least one pair 208k of substantially adjacent curved swarf-clearing grooves 210k, 212k, respectively, that extend across the width W of the cutting surface 204k, i.e., are contiguous from a first outer planar surface 214k to a second spaced and opposed outer planar surface 216k of the wheel 200k, wherein each of the grooves 210k, 212k, respectively, preferably has planar sides 218k, 220k, respectively, that extend substantially perpendicular to either outer planar surfaces 214k, 216k, respectively, and an optional gap 226k formed between the respective grooves 210k, 212k.

However, this embodiment differs in that two additional curved swarf-clearing grooves 222k and 224k respectively are provided in proximity to curved grooves 210k, 212k, respectively.

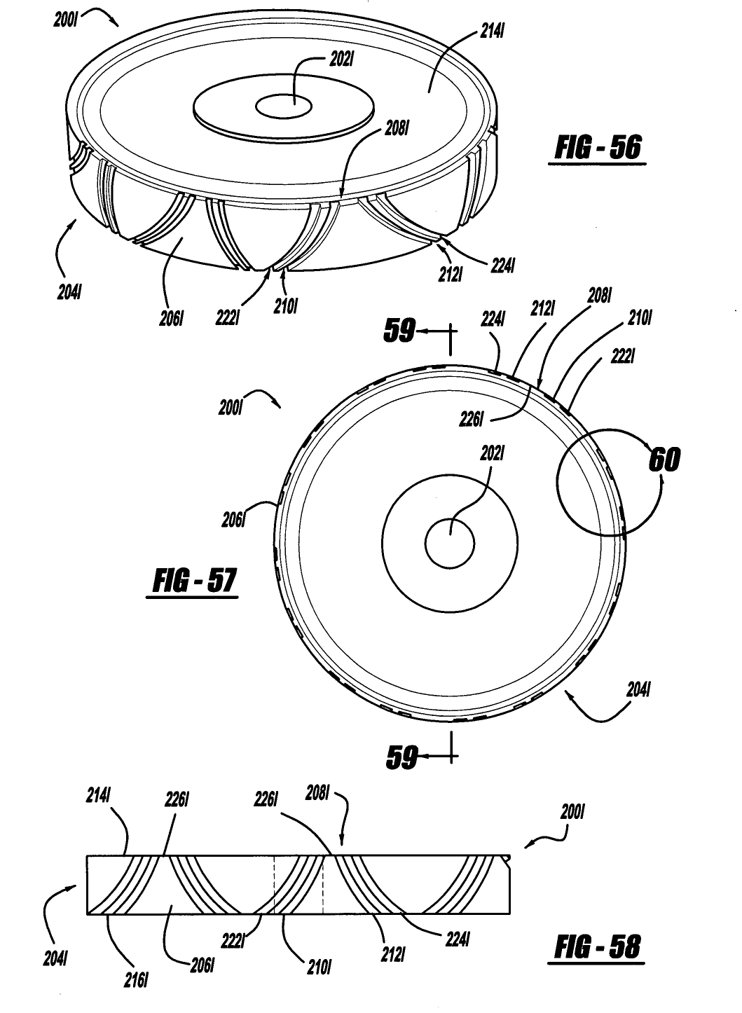

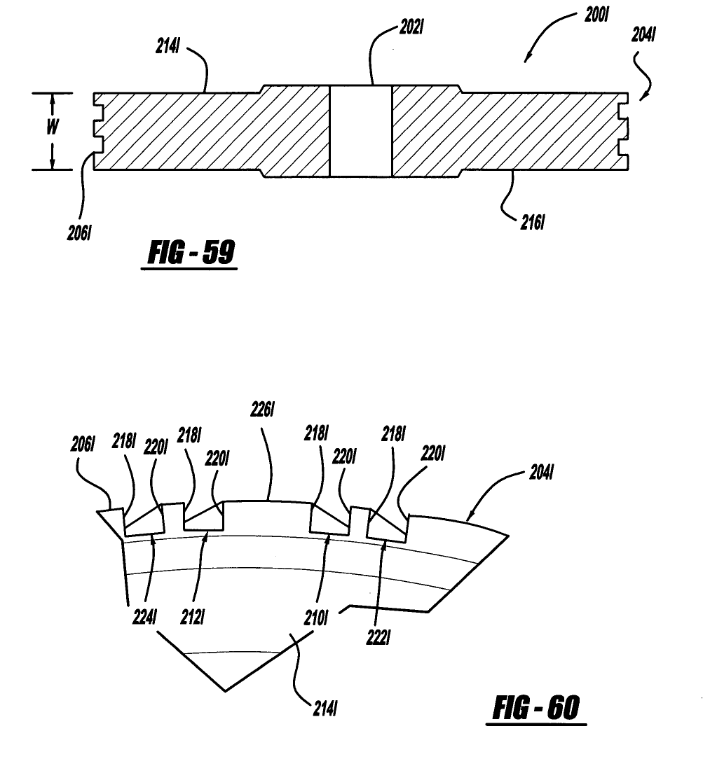

In accordance with a twelfth embodiment of the present invention, there is provided a fifth alternative polishing wheel generally shown at 200l for polishing of an optical lens, as shown in FIGS. 56-60. Again, the intended purpose of the polishing wheel 200l is to, among other things, facilitate the removal of swarf material.

The polishing wheel 200l is similar to the rough cutting wheel 200k shown in FIGS. 51-55, e.g., it includes a hub portion 202l, an outer circumferential cutting surface 204l (having a width W), an abrasive grit material 206l, at least one pair 208l of substantially adjacent curved swarf-clearing grooves 210l, 212l, 222l, 224l, respectively, that extend across the width W of the cutting surface 204l, i.e., are contiguous from a first outer planar surface 214l to a second spaced and opposed outer planar surface 216l of the wheel 200l, wherein each of the curved grooves 210l, 212l, 222l, 224l, respectively, preferably has planar sides 218l, 220l, respectively, that extend substantially perpendicular to either outer planar surfaces 214l, 216l, respectively, and an optional gap 226l formed between the respective grooves 210l, 212l.

However, as with the embodiment shown in FIGS. 6-10, because the polishing wheel 200l is intended for fine grinding and/or polishing of the optical lens, it is instead preferred to use an abrasive grit material that is much finer and thus less abrasive than the abrasive grit material 206 used for the rough cutting wheel 200. In accordance with a preferred embodiment of the present invention, the grit rating of the abrasive grit material 206l is preferably in the range of about 80 to about 600. It should be appreciated that grit rating outside of these ranges, i.e., less than 80 and/or greater than 600, may be used as well in the practice of the present invention, should circumstances require (e.g., material specific requirements).

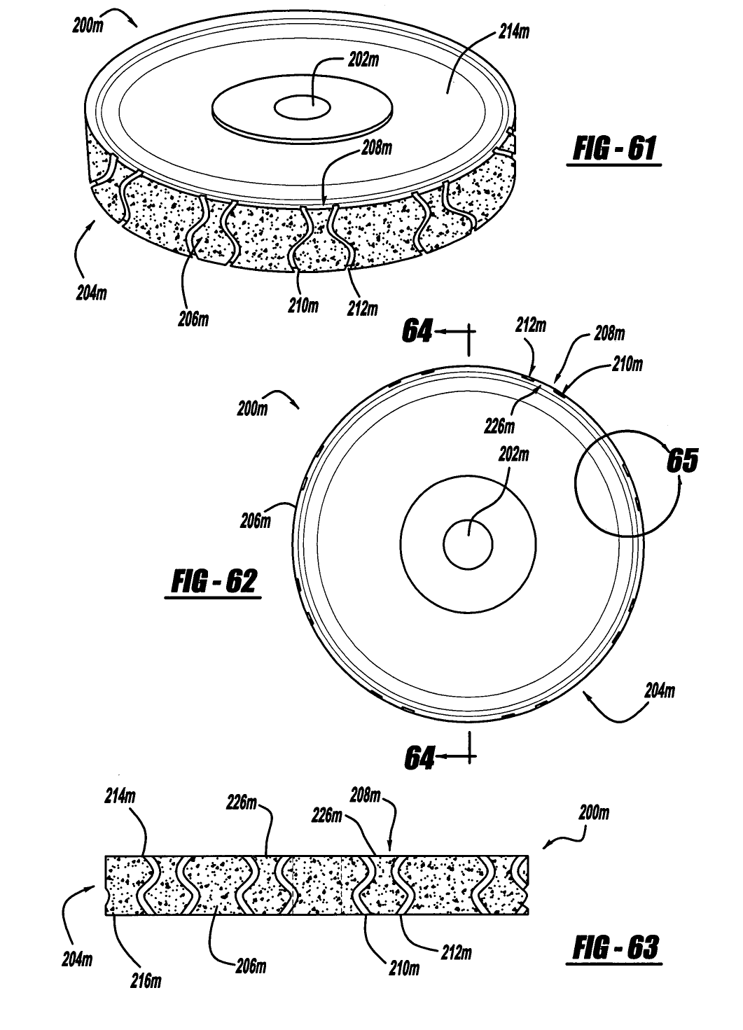

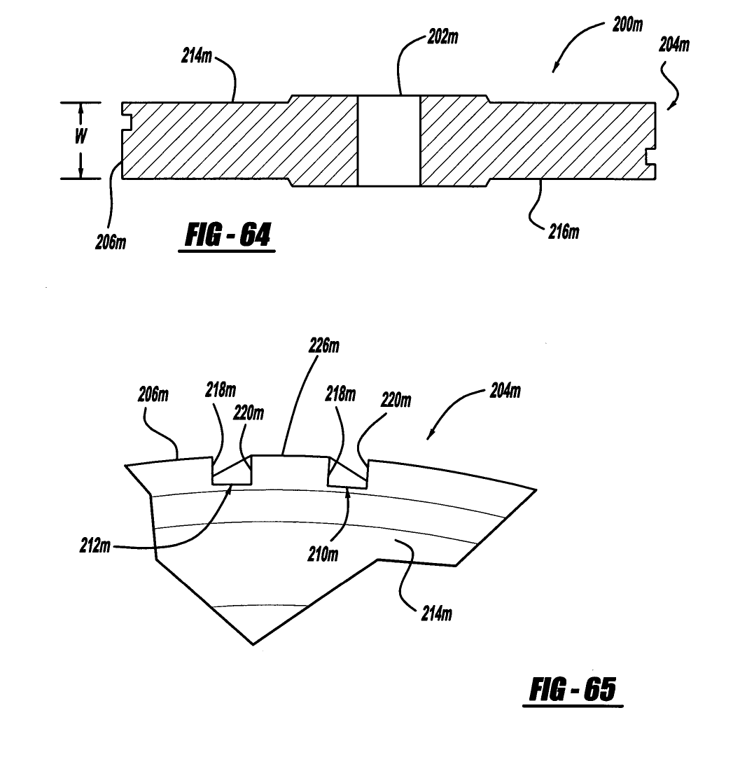

In accordance with a thirteenth embodiment of the present invention, there is provided a sixth alternative rough cutting wheel generally shown at 200m for rough cutting of an optical lens, as shown in FIGS. 61-65. Again, the intended purpose of the rough cutting wheel 200m is to, among other things, facilitate the removal of swarf material.

The rough cutting wheel 200m is similar to the rough cutting wheel 200i shown in FIGS. 41-45, e.g., it includes a hub portion 202m, an outer circumferential cutting surface 204m (having a width W), an abrasive grit material 206m, at least one pair 208m of substantially adjacent curved swarf-clearing grooves 210m, 212m, respectively, that extend across the width W of the cutting surface 204m, i.e., are contiguous from a first outer planar surface 214m to a second spaced and opposed outer planar surface 216m of the wheel 200m, wherein each of the grooves 210m, 212m, respectively, preferably has planar sides 218m, 220m, respectively, that extend substantially perpendicular to either outer planar surfaces 214m, 216m, respectively, and an optional gap 226m formed between the respective grooves 210m, 212m.

However, this embodiment differs in that the curved grooves 210m and 212m, respectively, are substantially serpentine in configuration, as opposed to being gradually curved.

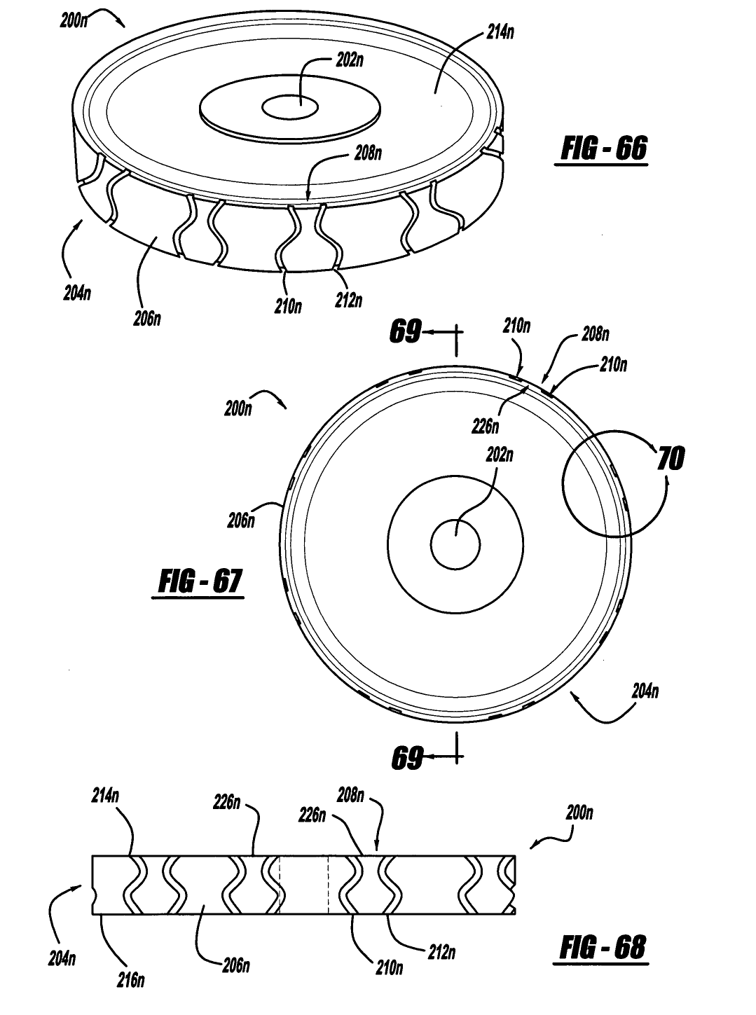

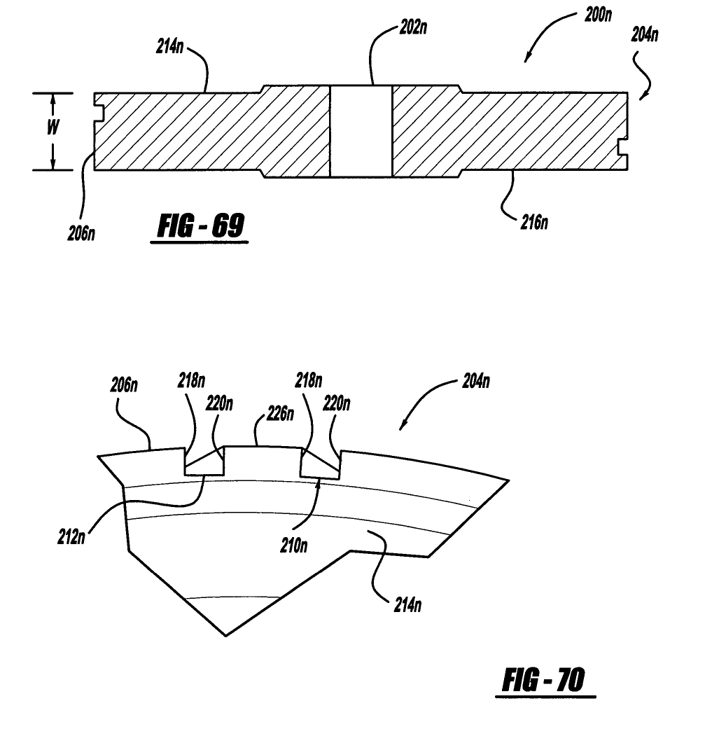

In accordance with a fourteenth embodiment of the present invention, there is provided a sixth alternative polishing wheel generally shown at 200n for polishing of an optical lens, as shown in FIGS. 66-70. Again, the intended purpose of the polishing wheel 200n is to, among other things, facilitate the removal of swarf material.

The polishing wheel 200n is similar to the rough cutting wheel 200m shown in FIGS. 61-65, e.g., it includes a hub portion 202n, an outer circumferential cutting surface 204n (having a width W), an abrasive grit material 206n, at least one pair 208n of substantially adjacent serpentine-shaped swarf-clearing grooves 210n, 212n, respectively, that extend across the width W of the cutting surface 204n, i.e., are contiguous from a first outer planar surface 214n to a second spaced and opposed outer planar surface 216n of the wheel 200n, wherein each of the serpentine-shaped grooves 210n, 212n, respectively, preferably has planar sides 218n, 220n, respectively, that extend substantially perpendicular to either outer planar surfaces 214n, 216n, respectively, and an optional gap 226n formed between the respective grooves 210n, 212n.

However, as with the embodiment shown in FIGS. 6-10, because the polishing wheel 200n is intended for fine grinding and/or polishing of the optical lens, it is instead preferred to use an abrasive grit material that is much finer and thus less abrasive than the abrasive grit material 206 used for the rough cutting wheel 200. In accordance with a preferred embodiment of the present invention, the grit rating of the abrasive grit material 206n is preferably in the range of about 80 to about 600. It should be appreciated that grit rating outside of these ranges, i.e., less than 80 and/or greater than 600, may be used as well in the practice of the present invention, should circumstances require (e.g., material specific requirements).

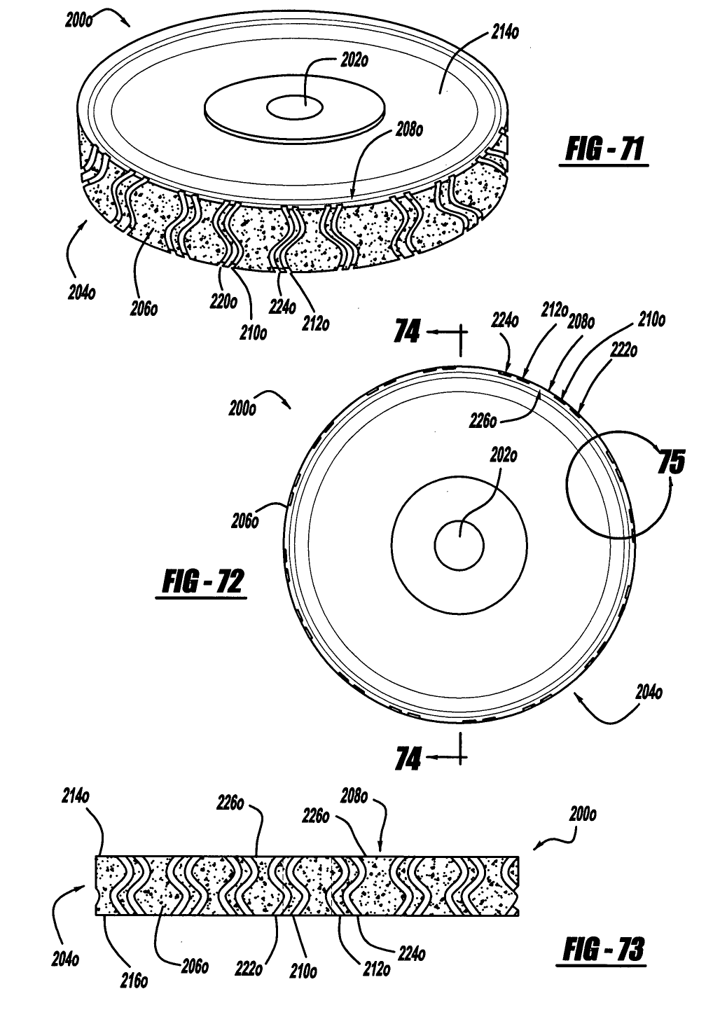

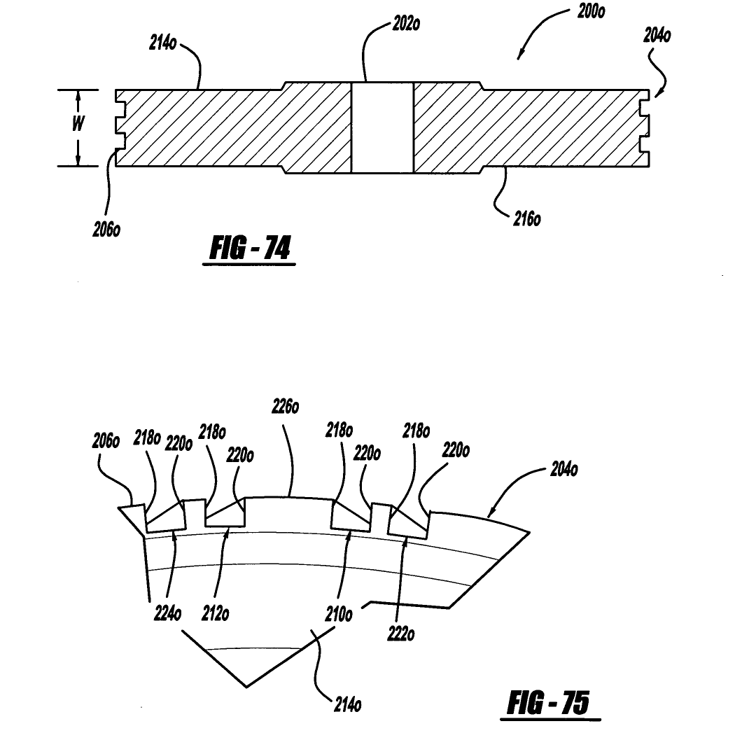

In accordance with a fifteenth embodiment of the present invention, there is provided a seventh alternative rough cutting wheel generally shown at 200o for rough cutting of an optical lens, as shown in FIGS. 71-75. Again, the intended purpose of the rough cutting wheel 200o is to, among other things, facilitate the removal of swarf material.

The rough cutting wheel 200o is similar to the rough cutting wheel 200m shown in FIGS. 61-65, e.g., it includes a hub portion 202o, an outer circumferential cutting surface 204o (having a width W), an abrasive grit material 206o, at least one pair 208o of substantially adjacent serpentine-shaped swarf-clearing grooves 210o, 212o, respectively, that extend across the width W of the cutting surface 204o, i.e., are contiguous from a first outer planar surface 214o to a second spaced and opposed outer planar surface 216o of the wheel 200o, wherein each of the serpentine-shaped grooves 210o, 212o, respectively, preferably has planar sides 218o, 220o, respectively, that extend substantially perpendicular to either outer planar surfaces 214o, 216o, respectively, and a gap 226o formed between the respective grooves 210o, 212o.

However, this embodiment differs in that two additional serpentine-shaped swarf-clearing grooves 222o and 224o respectively are provided in proximity to grooves 210o, 212o, respectively.

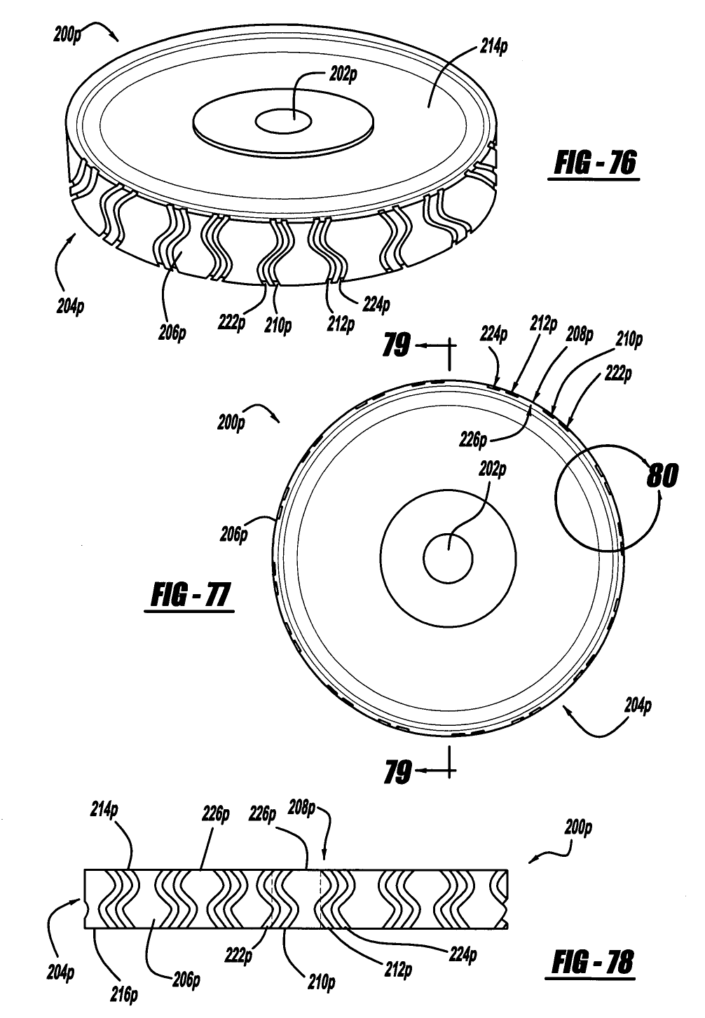

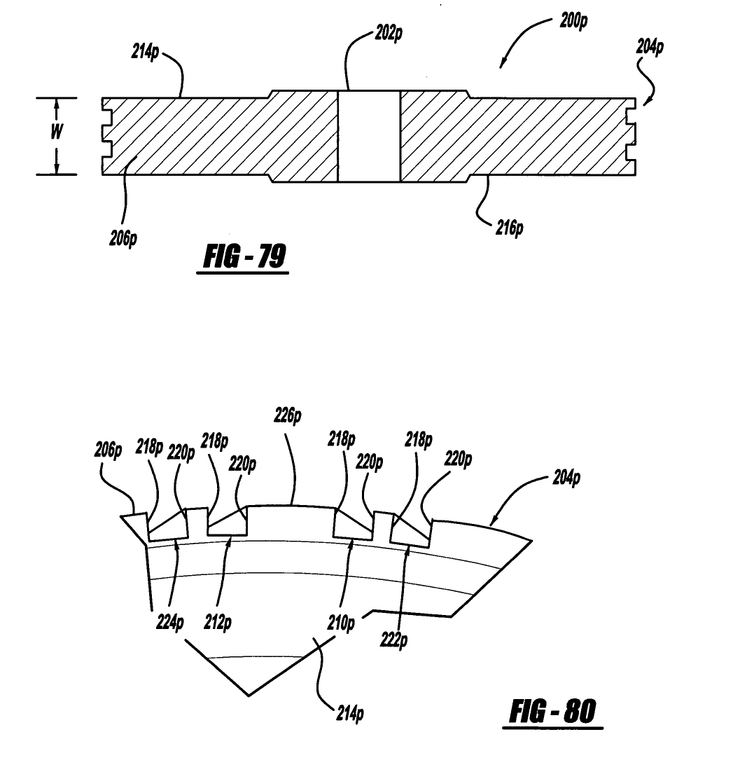

In accordance with a sixteenth embodiment of the present invention, there is provided a seventh alternative polishing wheel generally shown at 200p for polishing of an optical lens, as shown in FIGS. 76-80. Again, the intended purpose of the polishing wheel 200p is to, among other things, facilitate the removal of swarf material.

The polishing wheel 200p is similar to the rough cutting wheel 200o shown in FIGS. 71-75, e.g., it includes a hub portion 202p, an outer circumferential cutting surface 204p (having a width W), an abrasive grit material 206p, at least one pair 208p of substantially adjacent serpentine-shaped swarf-clearing grooves 210p, 212p, 222p, 224p, respectively, that extend across the width W of the cutting surface 204p, i.e., are contiguous from a first outer planar surface 214p to a second spaced and opposed outer planar surface 216p of the wheel 200p, wherein each of the serpentine-shaped grooves 210p, 212p, 222p, 224p, respectively, preferably has planar sides 218p, 220p, respectively, that extend substantially perpendicular to either outer planar surfaces 214p, 216p, respectively, and an optional gap 226p formed between the respective grooves 210p, 212p.

However, as with the embodiment shown in FIGS. 6-10, because the polishing wheel 200p is intended for fine grinding and/or polishing of the optical lens, it is instead preferred to use an abrasive grit material that is much finer and thus less abrasive than the abrasive grit material 206 used for the rough cutting wheel 200. In accordance with a preferred embodiment of the present invention, the grit rating of the abrasive grit material 206p is preferably in the range of about 80 to about 600. It should be appreciated that grit rating outside of these ranges, i.e., less than 80 and/or greater than 600, may be used as well in the practice of the present invention, should circumstances require (e.g., material specific requirements).

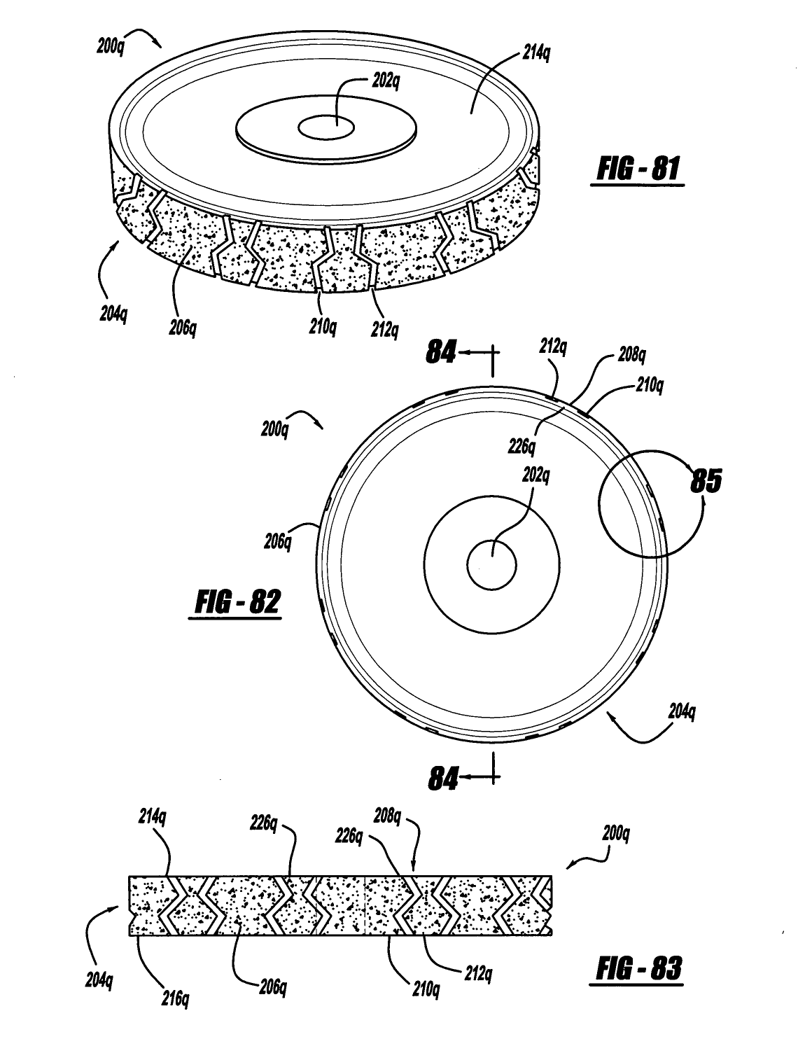

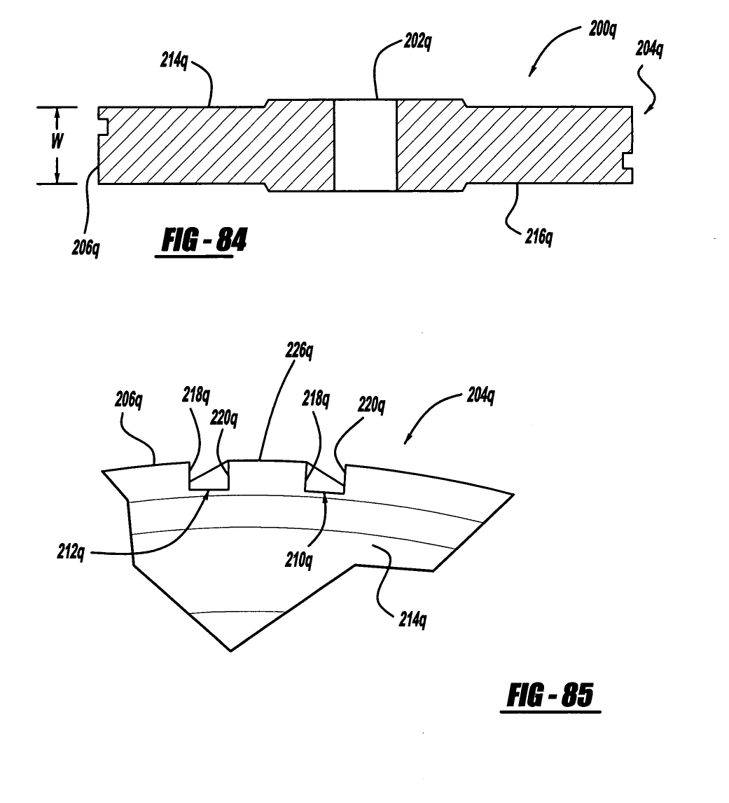

In accordance with a seventeenth embodiment of the present invention, there is provided an eighth alternative rough cutting wheel generally shown at 200q for rough cutting of an optical lens, as shown in FIGS. 81-85. Again, the intended purpose of the rough cutting wheel 200q is to, among other things, facilitate the removal of swarf material.

The rough cutting wheel 200q is similar to the rough cutting wheel 200m shown in FIGS. 61-65, e.g., it includes a hub portion 202q, an outer circumferential cutting surface 204q (having a width W), an abrasive grit material 206q, at least one pair 208q of substantially adjacent swarf-clearing grooves 210q, 212q, respectively, that extend across the width W of the cutting surface 204q, i.e., are contiguous from a first outer planar surface 214q to a second spaced and opposed outer planar surface 216q of the wheel 200q, wherein each of the grooves 210q, 212q, respectively, preferably has planar sides 218q, 220q, respectively, that extend substantially perpendicular to either outer planar surfaces 214q, 216q, respectively, and an optional gap 226q formed between the respective grooves 210q, 212q.

However, this embodiment differs in that the grooves 210q and 212q, respectively, are substantially zigzagged in configuration, as opposed to being gradually curved.

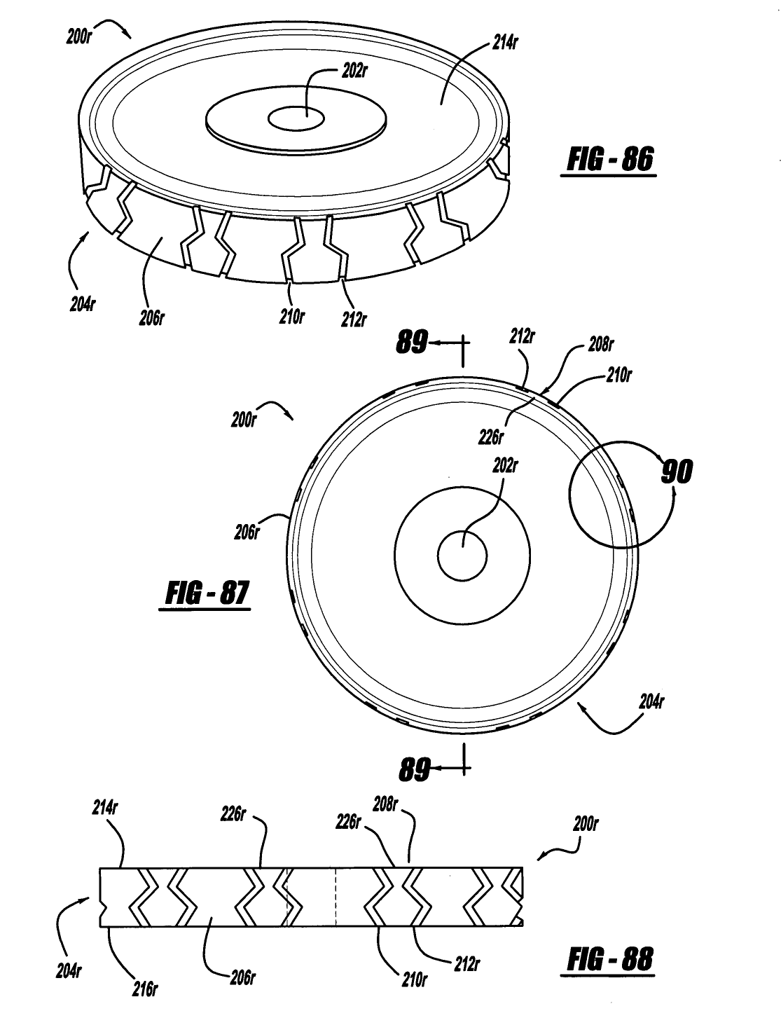

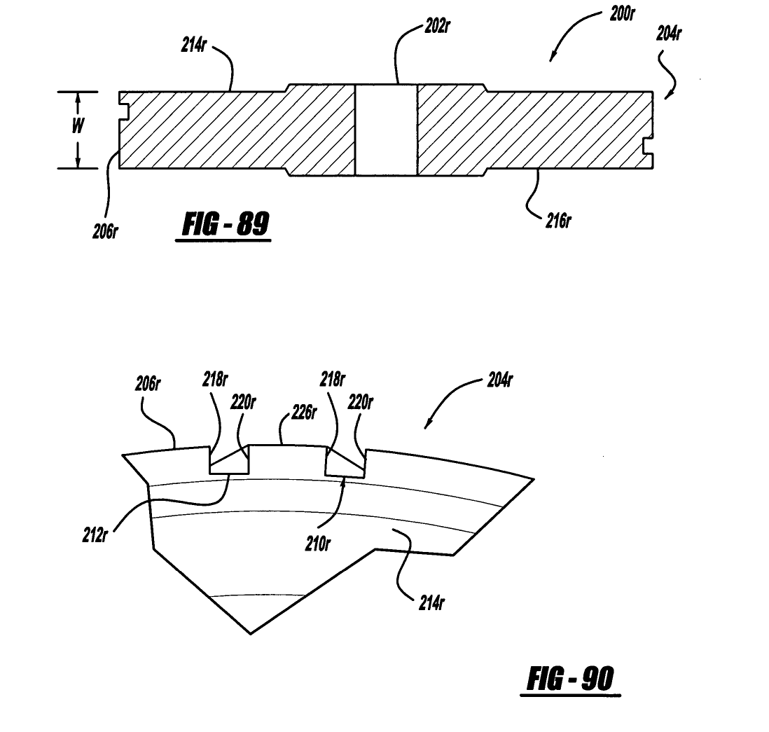

In accordance with an eighteenth embodiment of the present invention, there is provided an eighth alternative polishing wheel generally shown at 200r for polishing of an optical lens, as shown in FIGS. 86-90. Again, the intended purpose of the polishing wheel 200r is to, among other things, facilitate the removal of swarf material.

The polishing wheel 200r is similar to the rough cutting wheel 200q shown in FIGS. 81-85, e.g., it includes a hub portion 202r, an outer circumferential cutting surface 204r (having a width W), an abrasive grit material 206r, at least one pair 208r of substantially adjacent zigzagged-shaped swarf-clearing grooves 210r, 212r, respectively, that extend across the width W of the cutting surface 204r, i.e., are contiguous from a first outer planar surface 214r to a second spaced and opposed outer planar surface 216r of the wheel 200r, wherein each of the zigzagged-shaped grooves 210r, 212r, respectively, preferably has planar sides 218r, 220r, respectively, that extend substantially perpendicular to either outer planar surfaces 214r, 216r, respectively, and an optional gap 226r formed between the respective grooves 210r, 212r.

However, as with the embodiment shown in FIGS. 6-10, because the polishing wheel 200r is intended for fine grinding and/or polishing of the optical lens, it is instead preferred to use an abrasive grit material that is much finer and thus less abrasive than the abrasive grit material 206 used for the rough cutting wheel 200. In accordance with a preferred embodiment of the present invention, the grit rating of the abrasive grit material 206r is preferably in the range of about 80 to about 600. It should be appreciated that grit rating outside of these ranges, i.e., less than 80 and/or greater than 600, may be used as well in the practice of the present invention, should circumstances require (e.g., material specific requirements).

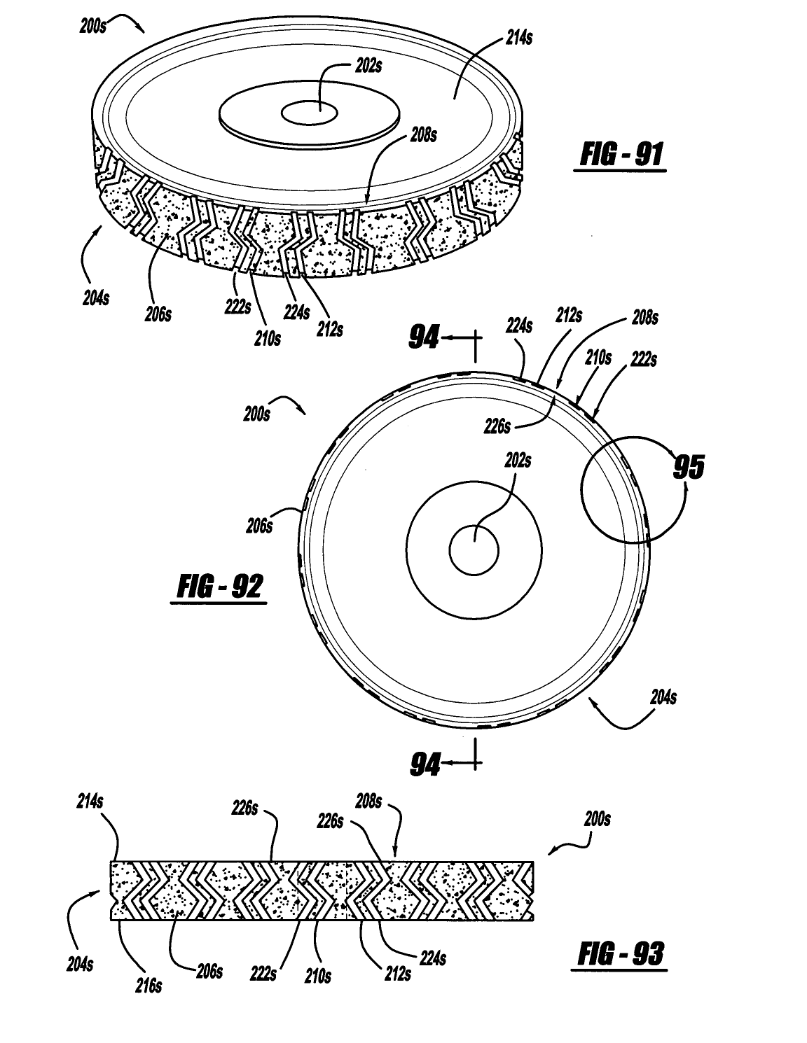

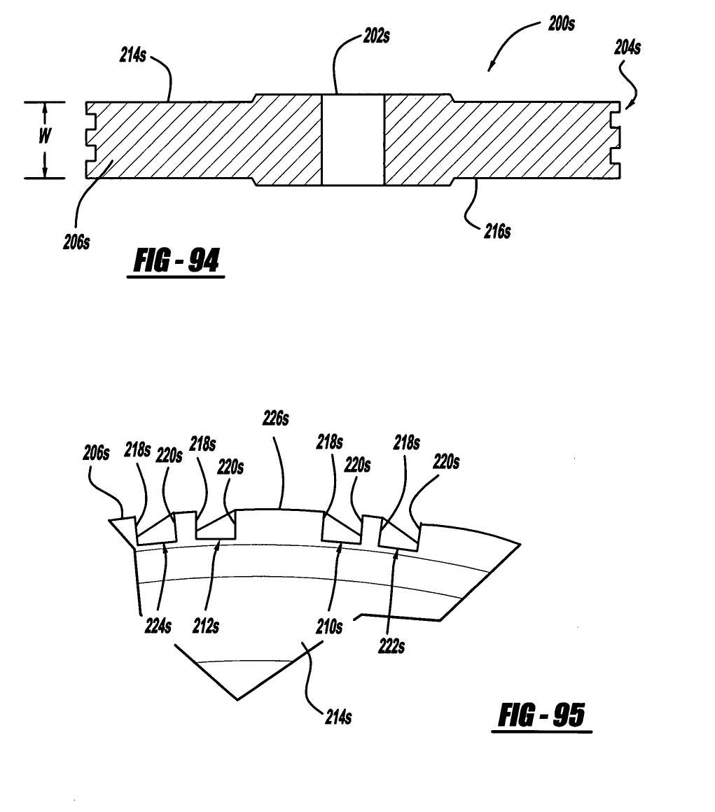

In accordance with a nineteenth embodiment of the present invention, there is provided a ninth alternative rough cutting wheel generally shown at 200s for rough cutting of an optical lens, as shown in FIGS. 91-95. Again, the intended purpose of the rough cutting wheel 200s is to, among other things, facilitate the removal of swarf material.

The rough cutting wheel 200s is similar to the rough cutting wheel 200q shown in FIGS. 81-85, e.g., it includes a hub portion 202s, an outer circumferential cutting surface 204s (having a width W), an abrasive grit material 206s, at least one pair 208s of substantially adjacent zigzagged-shaped swarf-clearing grooves 210s, 212s, respectively, that extend across the width W of the cutting surface 204s, i.e., are contiguous from a first outer planar surface 214s to a second spaced and opposed outer planar surface 216s of the wheel 200s, wherein each of the serpentine-shaped grooves 210q, 212s, respectively, preferably has planar sides 218s, 220s, respectively, that extend substantially perpendicular to either outer planar surfaces 214s, 216s, respectively, and a gap 226s formed between the respective grooves 210s, 212s.

However, this embodiment differs in that two additional zigzagged-shaped swarf-clearing grooves 222s and 224s respectively are provided in proximity to grooves 210s, 212s, respectively.

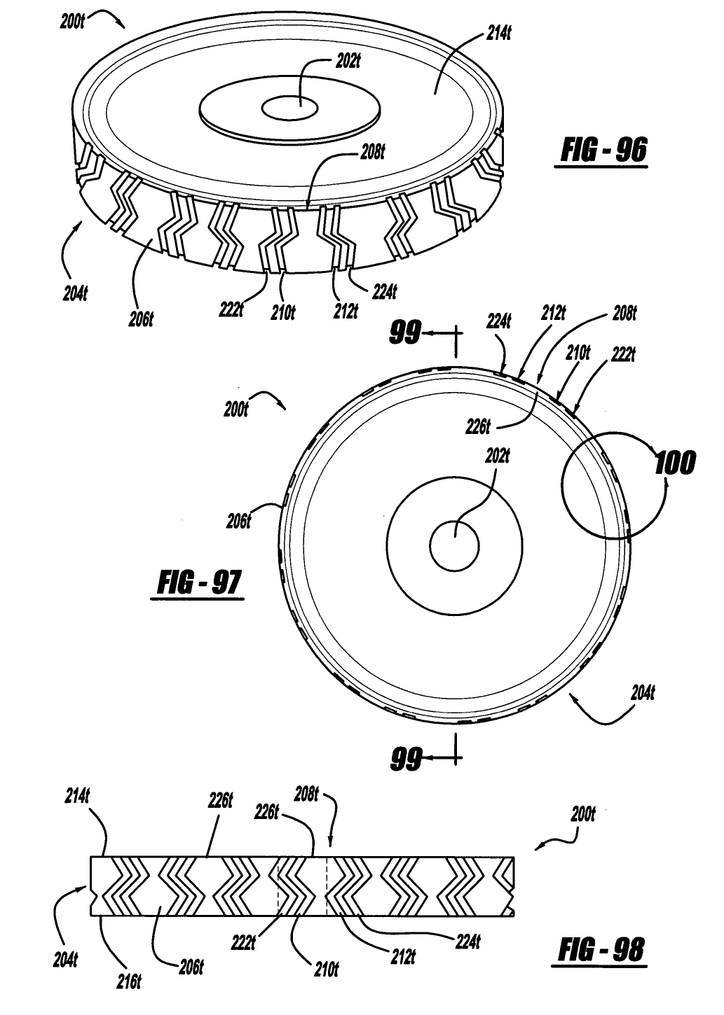

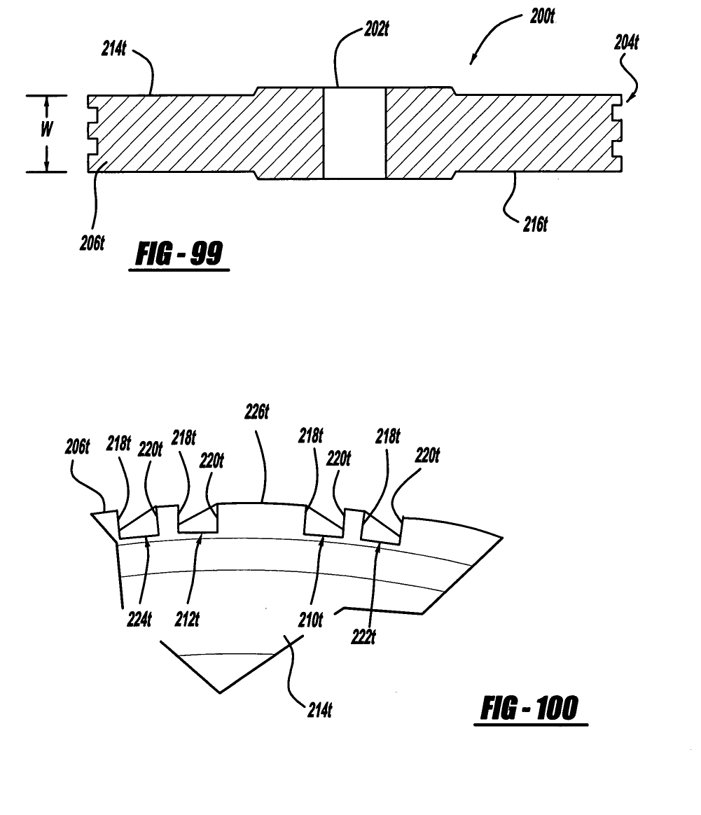

In accordance with a twentieth embodiment of the present invention, there is provided a ninth alternative polishing wheel generally shown at 200t for polishing of an optical lens, as shown in FIGS. 96-100. Again, the intended purpose of the polishing wheel 200t is to, among other things, facilitate the removal of swarf material.

The polishing wheel 200t is similar to the rough cutting wheel 200s shown in FIGS. 91-95, e.g., it includes a hub portion 202t, an outer circumferential cutting surface 204t (having a width W), an abrasive grit material 206t, at least one pair 208t of substantially adjacent zigzagged-shaped swarf-clearing grooves 210t, 212t, 222t, 224t, respectively, that extend across the width W of the cutting surface 204t, i.e., are contiguous from a first outer planar surface 214t to a second spaced and opposed outer planar surface 216t of the wheel 200t, wherein each of the zigzagged-shaped grooves 210t, 212t, 222t, 224t, respectively, preferably has planar sides 218t, 220t, respectively, that extend substantially perpendicular to either outer planar surfaces 214t, 216t, respectively, and an optional gap 226t formed between the respective grooves 210t, 212t.

However, as with the embodiment shown in FIGS. 6-10, because the polishing wheel 200t is intended for fine grinding and/or polishing of the optical lens, it is instead preferred to use an abrasive grit material that is much finer and thus less abrasive than the abrasive grit material 206 used for the rough cutting wheel 200. In accordance with a preferred embodiment of the present invention, the grit rating of the abrasive grit material 206t is preferably in the range of about 80 to about 600. It should be appreciated that grit rating outside of these ranges, i.e., less than 80 and/or greater than 600, may be used as well in the practice of the present invention, should circumstances require (e.g., material specific requirements).

It should also be appreciated that other configurations may be employed with the grooves of the present invention. By way of a non-limiting example, crisscross or “X-shaped” patterns can be used as well in the practice of the present invention.

The use of the described wheels, whether for rough cutting, fine grinding, finishing, polishing, beveling, or the like, is fairly straightforward. The wheel is preferably mounted to a rotary motion machine, which preferably allows the wheel to selectively rotate about an axis, wherein at least a portion of the cutting face is accessible (e.g., by a work piece such as an optical lens blank). The wheel is then rotated while an optical lens blank is brought into contact with the rotating wheel for a sufficient period of time. As swarf material is generated by the frictional engagement, the swarf material is preferably carried away from the surface of the optical lens blank and/or the wheel by the swarf-clearing grooves of the present invention. It will be appreciated that the choice of wheel will be dependent, in part, on the particular action to be carried out, e.g., rough cutting, fine grinding, finishing, polishing, beveling, or the like. Thus, in the production of a particular finished optical lens, it may be necessary to employ multiple types of wheels, e.g., one for rough cutting, one for fine grinding, one for finishing, one for polishing, one for beveling, and so forth, to perform the required cutting, grinding, finishing, polishing, or beveling functions.

Testing of the wheels of the present invention have shown an increase in the ease of swarf material removal during the grinding process, a reduction in the number of burrs on the edge surfaces of the optical lens blanks, a reduction in grinding noise levels, and a reduction in odor levels due to the grinding process. Additionally, wheels of the present invention cut cool enough to allow grinding of TRIVEX™ and polycarbonate lens materials substantially without melting. The present invention allows cooler cutting and improved edge finishing qualities whether in rough cutting, finish cutting or polishing operations.

Those skilled in the art can now appreciate from the foregoing description that the broad teachings of the present invention can be implemented in a variety of forms. Therefore, while this invention has been described in connection with particular examples thereof, the true scope of the invention should not be so limited, since other modifications will become apparent to the skilled practitioner upon a study of the drawings, specification and following claims.

1. A rotary edging wheel for rough cutting of an optical lens, comprising:
a hub portion operable for attachment to a rotary power source, wherein said hub portion includes a substantially solid body member;
an outer circumferential rough cutting surface having a width, wherein said surface is adjacent to said body member, said surface including an abrasive grit attached thereto, wherein said abrasive grit is operable for rough cutting of the optical lens, wherein said abrasive grit is present at a substantially level depth across the width of said surface; and
at least one pair of substantially adjacent swarf clearing grooves formed in said surface, comprising:
a first swarf clearing groove extending at an angle across said surface;
a second swarf clearing groove extending at an angle across said surface;
wherein said first and second swarf clearing grooves are angled either towards each other or away from each other and extend continuously across said surface; and
wherein said first and second swarf clearing grooves are operable to remove swarf during a rough cutting operation.

2. The invention of claim 1, further comprising a plurality of pairs of substantially adjacent swarf clearing grooves formed in said surface.

3. The invention of claim 1, wherein each groove has an angle of from about 10 degrees to about 80 degrees.

4. The invention of claim 1, wherein each groove has an angle of from about 15 degrees to about 65 degrees.

5. The invention of claim 1, wherein each groove has an angle of from about 35 degrees to about 45 degrees.

6. The invention of claim 1, wherein said abrasive grit is attached to the wheel by brazing, electroplating, sintering or resin bonding.

7. The invention of claim 1, wherein said abrasive grit is comprised of diamond hardness grit.

8. A rotary edging wheel for rough cutting of an optical lens, comprising:
a hub portion operable for attachment to a rotary power source;
an outer circumferential rough cutting surface having a width, said surface including an abrasive grit attached thereto, wherein said abrasive grit is operable for rough cutting of the optical lens;
a first pair of substantially adjacent swarf clearing grooves formed in said surface, comprising first and second substantially parallel swarf clearing grooves extending at an angle across said surface; and
a second pair of substantially adjacent swarf clearing grooves formed in said surface, comprising third and fourth substantially parallel second swarf clearing grooves extending at an angle across said surface;
wherein said first and second pairs of swarf clearing grooves are angled either towards each other or away from each other and extend continuously across said surface.

9. The invention of claim 8, further comprising a plurality of pairs of substantially adjacent swarf clearing grooves formed in said surface.

10. The invention of claim 8, wherein each groove has an angle of from about 10 degrees to about 80 degrees.

11. The invention of claim 8, wherein each groove has an angle of from about 15 degrees to about 65 degrees.

12. The invention of claim 8, wherein each groove has an angle of from about 35 degrees to about 45 degrees.

13. The invention of claim 8, wherein said abrasive grit is attached to the wheel by brazing, electroplating, sintering or resin bonding.

14. The invention of claim 8, wherein said abrasive grit is comprised of diamond hardness grit.

15. A rotary edging wheel for polishing of an optical lens, comprising:
a hub portion operable for attachment to a rotary power source, wherein said hub
portion includes a substantially solid body member;
an outer circumferential cutting surface having a width, wherein said surface is adjacent to said body member, said surface including an abrasive grit attached thereto, wherein said abrasive grit is operable for polishing of the optical lens, wherein said abrasive grit is present at a substantially level dept across the width of said surface; and
at least one pair of substantially adjacent swarf clearing grooves formed in said surface, comprising:
a first swarf clearing groove extending at an angle across said surface;
a second swarf clearing groove extending at an angle across said surface;
wherein said first and second swarf clearing grooves are angled either towards each other or away from each other and extend continuously across said surface; and
wherein said first and second swart clearing grooves are operable to remove swarf during a polishing cutting operation of the optical lens.

16. The invention of claim 15, further comprising a plurality of pairs of substantially adjacent swarf clearing grooves formed in said surface.

17. The invention of claim 15, wherein each groove has an angle of from about 10 degrees to about 80 degrees.

18. The invention of claim 15, wherein each groove has an angle of from about 15 degrees to about 65 degrees.

19. The invention of claim 15, wherein each groove has an angle of from about 35 degrees to about 45 degrees.

20. The invention of claim 15, wherein said abrasive grit is attached to the wheel by brazing, electroplating, sintering or resin bonding.

21. The invention of claim 15, wherein said abrasive grit is comprised of diamond hardness grit.

22. A rotary edging wheel for polishing of an optical lens, comprising:
a hub portion operable for attachment to a rotary power source;
an outer circumferential cutting surface having a width, said surface including an abrasive grit attached thereto, wherein said abrasive grit is operable for polishing of the optical lens;
a first pair of substantially adjacent swarf clearing grooves formed in said surface, comprising first and second substantially parallel swarf clearing grooves extending at an angle across said surface; and
a second pair of substantially adjacent swarf clearing grooves formed in said surface, comprising third and fourth substantially parallel second swarf clearing grooves extending at an angle across said surface;
wherein said first and second pairs of swarf clearing grooves are angled either towards each other or away from each other and extend continuously across said surface.

23. The invention of claim 22, further comprising a plurality of pairs of substantially adjacent swarf clearing grooves formed in said surface.

24. The invention of claim 22, wherein each groove has an angle of from about 10 degrees to about 80 degrees.

25. The invention of claim 22, wherein each groove has an angle of from about 15 degrees to about 65 degrees.

26. The invention of claim 22, wherein each groove has an angle of from about 35 degrees to about 45 degrees.

27. The invention of claim 22, wherein said abrasive grit is attached to the wheel by brazing, electroplating, sintering or resin bonding.

28. The invention of claim 22, wherein said abrasive grit is comprised of diamond hardness grit.

29. A method for rough cutting of an optical lens, comprising:
providing an edging wheel, comprising:
a hub portion operable for attachment to a rotary power source, wherein said hub portion includes a substantially solid body member;
an outer circumferential rough cutting surface having a width, wherein said surface is adjacent to said body member, said surface including an abrasive grit attached thereto, wherein said abrasive grit is operable for rough cutting of the optical lens, wherein said abrasive grit is present at a substantially level depth across the width of said surface; and
at least one pair of substantially adjacent swarf clearing grooves formed in said surface, comprising:
a first swarf clearing groove extending at an angle across said surface; and
a second swarf clearing groove extending at an angle across said surface;
wherein said first and second swarf clearing grooves are angled either towards each other or away from each other and extend continuously across said surface;
wherein said first and second swart clearing grooves are operable to remove swart during a rough cutting operation of the optical lens;
selectively rotating said edging wheel; and
bringing the optical lens into selective contact with said rotating edging wheel.

30. A method for rough cutting of an optical lens, comprising:
providing a rotary edging wheel, comprising:
a hub portion operable for attachment to a rotary power source;
an outer circumferential rough cutting surface having a width, said surface including an abrasive grit attached thereto, wherein said abrasive grit is operable for rough cutting of the optical lens;
a first pair of substantially adjacent swarf clearing grooves formed in said surface, comprising first and second substantially parallel swarf clearing grooves extending at an angle across said surface; and
a second pair of substantially adjacent swarf clearing grooves formed in said surface, comprising third and fourth substantially parallel second swarf clearing grooves extending at an angle across said surface and extend continuously across said surface;
wherein said first and second pairs of swarf clearing grooves are angled either towards each other or away from each other;
selectively rotating said edging wheel; and bringing the optical lens into selective contact with said rotating edging wheel.

31. A method for polishing of an optical lens, comprising:
providing a rotary edging wheel, comprising:
a hub portion operable for attachment to a rotary power source, wherein said hub portion includes a substantially solid body member;
an outer circumferential cutting surface having a width, wherein said surface is adjacent to said body member, said surface including an abrasive grit attached thereto, wherein said abrasive grit is operable for polishing of the optical lens, wherein said abrasive grit is present at a substantially level depth across the width of said surface; and
at least one pair of substantially adjacent swarf clearing grooves formed in said surface, comprising:
a first swarf clearing groove extending at an angle across said surface; and
a second swarf clearing groove extending at an angle across said surface;
wherein said first and second swarf clearing grooves are angled either towards each other or away from each other and extend continuously across said surface;
wherein said first and second swart clearing grooves are operable to remove swart during a polishing operation of the optical lens;
selectively rotating said edging wheel; and
bringing the optical lens into selective contact with said rotating edging wheel.

32. A method for polishing an optical lens, comprising:
providing a rotary edging wheel, comprising:
a hub portion operable for attachment to a rotary power source;
an outer circumferential cutting surface having a width, said surface including an abrasive grit attached thereto, wherein said abrasive grit is operable for polishing of the optical lens;
a radially extending planar side portion;
a first pair of substantially adjacent swarf clearing grooves formed in said surface, comprising first and second substantially parallel swarf clearing grooves extending at an angle across said surface; and
a second pair of substantially adjacent swarf clearing grooves formed in said surface, comprising third and fourth substantially parallel second swarf clearing grooves extending at an angle across said surface;
wherein said first and second pairs of swarf clearing grooves are angled either towards each other or away from each other and extend continuously across said surface;
selectively rotating said edging wheel; and
bringing the optical lens into selective contact with said rotating edging wheel.
